(19) United States
(12) Patent Application Publication
(10) Pub. No.: US 2026/0197302 A1
(43) Pub. Date: Jul. 9, 2026

(54) Apparatus and Method for Blocking Malicious Code Embedded in Digital Data

(71) Applicants: James Paul Stewart Snyder, Lexington, KY (US); John Compton, Ashland, KY (US); Dennis Groves, Scottsdale, AZ (US)

(72) Inventors: James Paul Stewart Snyder, Lexington, KY (US); John Compton, Ashland, KY (US); Dennis Groves, Scottsdale, AZ (US)

(21) Appl. No.: 19/550,511

(22) Filed: Feb. 26, 2026

Related U.S. Application Data
(63) Continuation-in-part of application No. 18/097,321, filed on Jan. 16, 2023.

(51) Int. Cl. H04L 9/40; H03M 1/66

(52) U.S. Cl. CPC H04L 63/0428; H03M 1/66

(57) ABSTRACT

The present invention is a device, system, and method for improving network security using pictorial communication and in preferred embodiments immutable processing for the communication of digital information to block malicious code embedded in digital data. More specifically, the present invention in certain embodiments receives a digital data stream from an open network; identifies and extracts desired digital content from the digital data stream; deletes all remaining digital data; displays the extracted digital content as pictorial images containing alphanumeric or other characters on one side of an analog air gap; captures the pictorial images on the opposite side of the analog air gap in a closed network; and optionally converts the pictorial images to a digital character stream or outputs analog character representations for photonic processing and storage.

### CROSS-REFERENCE TO RELATED APPLICATIONS

This application is a continuation-in-part of U.S. application Ser. No. 18/097,321, filed Jan. 16, 2023, which claims the benefit of U.S. Provisional Application No. 63/266,861, filed Jan. 17, 2022. The disclosures of these applications are incorporated by reference herein in their entireties.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### COPYRIGHT NOTICE

A portion of the disclosure of this patent document contains material to which a claim for copyright is made. The copyright owner has no objection to the facsimile reproduction by anyone of the patent document or the patent disclosure, as it appears in the Patent and Trademark Office patent file or records but reserves all other copyright rights whatsoever.

### FIELD OF THE INVENTION

Embodiments of the disclosure relate to the field of cybersecurity. The present invention relates generally to network security and the use of pictorial communication for the transmission of digital information to block malicious code embedded in digital data, and more particularly, but without limitation, to an apparatus and method for receiving a digital data stream from an open network source; identifying and extracting digital content from the data, such as personal and business information intended for use in commercial transactions; deletion of the remaining digital data stream; display of the extracted digital content as an image of pictorial characters and/or other pictorial information on a monitor or similar display apparatus located on one side of an air gap; capture on the opposite side of the air gap of the displayed pictorial image by an image sensor; conversion of the captured pictorial image to a digital image file in a closed network; and parsing of the digital image file using optical character recognition algorithms for recognition and digital encoding of images of pictorial characters; and storage of the encoded pictorial characters and/or other pictorial information in a clean digital content file within a secure physically isolated data facility. In additional embodiments, the digital data stream is processed exclusively by immutable processors executing immutable instructions, extracting digital characters encoding content, converting them to analog characters, and communicating them across an analog air gap as analog character representations lacking executable semantics; and optionally outputting the data to a closed network as non-executable digital characters or analog photonic characters.

### BACKGROUND OF THE INVENTION

Digital data generally refers to information placed in a prescribed digital binary format that is transmitted, processed, and/or stored in accordance with suitable protocols, and that is accessible through a logical data structure. For example, but without limitation, digital data may consist of information in digital binary format containing medical records, financial ledgers, corporate documents, commercial transactions, legal instruments, personally identifiable information, and/or any other information which is capable of being represented and encoded in a digital format.

Current cybersecurity devices and methods are designed to recognize and extract malicious code embedded within a digital object, for example ransomware embedded in a digital data file, electronic mail message, or web content. They typically extract malicious code by comparison of the digital bits and bytes within the data with known patterns of malicious code; deploying an analysis system in a virtual sandbox environment to conduct behavioral analyses on model targets; the use of artificial intelligence and machine learning algorithms to predict malicious behaviors from unknown threats; and/or other similar methods. If code suspected as being malicious is identified, it is extracted and quarantined in isolated sections of computer memory commonly referred to as sandboxes.

Existing devices and methods expend substantial computational resources searching for malicious code and consistently fail to detect cybercriminal exploits until after significant loss or damage has occurred. It is generally accepted by government and private experts that the detection and extraction of all known and unknown (zero day) malicious code is impossible, and that malicious code will continue to be surreptitiously inserted into digital data (see, https://www.cisa.gov).

Furthermore, the risk of denial-of-service attacks, as well as system and/or data corruption, remains high when a more secure closed network receives digital data from an open network. Bidirectional communication between a closed network and open network also increases the likelihood of sensitive data leaking from the closed network to the open network.

In recognition of the unabated risk of malicious code, cybersecurity devices and methods attempt to minimize the vulnerability of digital data to cyberthreats by reducing the exposure of the data to threat vectors. A preferred method of improving data protection is the one-way transmission of digital information believed not to contain malicious code from an open network to a more secure closed network.

Closed networks are assumed to be less likely to experience security breaches than open networks. Existing cybersecurity devices and methods typically use one way data diodes or similar devices to allow data to travel in one direction only from an open network source into a more secure closed network, and from the closed network to a destination network. Data diodes operate somewhat like a telegram by sending unidirectional modulated light pulses across an air gap, and are the basic component of most existing prior art.

Prior art that provides or attempt to provide similar computer and/or network security includes: U.S. Pat. No. 8,646,094 to Staubly ('094 Patent), which discloses an apparatus for providing secure data transfer through system devices which include a one way data link; U.S. Pat. No. 8,831,222 to Menoher et al. ('222 Patent), which discloses a transmission system that includes bilateral unidirectional data transfer; U.S. Pat. No. 8,498,206 to Mraz ('206 Patent), which discloses system interface circuitry which is asserted to provide secure one way data transfer; U.S. Pat. No. 8,380,913 to Goldring ('913 Patent), which discloses a data diode device; U.S. Pat. No. 8,068,415 Mraz ('415 Patent), which discloses network interface circuitry that restricts which network components can send and receive data; U.S. Pat. No. 8,250,235 to Harvey et al. ('235 Patent), which discloses a method and system for one way transfer of data with transmission of a data receipt to the sending network; and U.S. Pat. No. 6,108,787 to Anderson et al. ('787 Patent), which discloses a method and means for interconnecting different security networks through use of a diode and a switch; U.S. Pat. No. 9,967,234 to Crane et al., (Crane or '234 Patent) which discloses a device and method to secure live full motion video with metadata by transferring a video image; U.S. Pat. No. 10,530,748 to Retvold et al. ('748 Patent) which discloses a fiber optic method for transmitting optical signals; U.S. App. Pub. No. 2020/0336808A to Menoher, which discloses a fiber optic method for transmitting optical signals using artificial intelligence and a one way data flow device; and U.S. Pat. No. 6,400,845 B1, Volino suggests the use of OCR of the image to create a data file.

Digital data files that include digital content may include malicious code. Obfuscation and advanced steganography techniques may be employed to prevent the detection of the malicious code. A data stream might include two consecutive 8 bit bytes, 01000001 and 01111111. The first byte may be interpreted by a digital processor as a valid ASCII digital code for the capital letter A. The second byte 01111111 is a valid delete character in the ASCII character set (Char #127). However, the same character #127 also encodes a dark blue color (RGB hex #00007f) when interpreted as component of a digital image and a jump opcode (JNLE) in the Intel 8086 processor instruction set when interpreted as an executable program.

Firewalls, and other devices and methods currently used to prevent malicious behaviors, attempt to recognize malicious code and quarantine it so that the code is not transmitted in a digital data stream. Firewalls apply rule sets to recognize and detect malware. The National Institute of Standards and Technology (NIST) notes that rule sets need to be frequently reviewed to provide adequate protection in light of ever changing security threats. Whether or not the second byte in the example (01111111) would be detected as a processor instruction in a possible malicious code sequence or would be allowed to cross an air gap as a valid ASCII and/or RGB value, depends on the malware detection algorithms and rules applied by the firewall. Assuming that the second byte is a jump opcode in a string of malicious code, it will be transmitted from the open network to the closed network if the firewall wrongly interprets it as an encoded RGB dark blue color.

To remove malware, firewalls and other malware detection algorithms must detect malicious code. Because malicious code threat vectors are constantly changing, the possibility always exists that they may allow transmission of obfuscated known malicious code or unknown (zero day) malware into a more secure network. As a result of the impossibility of detection and extraction of all known and unknown malicious digital code, current methods of transfer of digital data from open to closed networks cannot eliminate risk of transmission into the closed network of undetected malicious code embedded in digital data. The present invention addresses limitations of all existing devices and methods in that it identifies and extracts digital content and deletes all other digital code, blocking cyberthreats without requiring recognition and identification of malicious code.

On first consideration it would seem that detecting and removing malicious code from a digital image, displaying the digital image, and capturing it on a camera, would be as secure as extracting and displaying the digital content in a data stream, but this is not the case. A still or video digital image consists of digital code which can manipulate pixels on a digital monitor in addition to the pixels used to display digital content. For example, but without limitation, a QR code may be incorporated into a picture to appear as a harmless out of focus smudge. When captured by an image sensor the hidden QR code can inject malicious code into the closed network. A reasonable threat exists that digital data containing malicious code hidden in digital images may be reconstructed inside a secure closed network.

The Crane '234 Patent purports to generate a clean video data stream by passing digital video images through a firewall on an open network module to identify and remove malicious code, before displaying and capturing the live digital images in a more secure module. The displayed images do not have as their source a data stream constructed from extracted digital content only. Displaying a live video after the digital data stream has been parsed by the firewall may include pixel patterns generated by any malicious code that was not detected.

Prior art, including Volino and Crane, does not address two vulnerabilities. First, existing digital devices execute defensive algorithms that must detect malicious code to prevent the transfer of the malicious code into a secure network. The fundamental problem is that unrecognized obfuscated and zero-day malicious code cannot be detected and prevented from disabling or bypassing digital defenses until after the malicious code is executed and damage is done. Digital filtering systems are vulnerable to attacks that leverage unrecognized behaviors, undefined processor states, parser ambiguities, memory corruption, logic errors, or zero-day exploits that have not yet been identified or patched. Because such defenses may rely on mutable software, firmware, microcode, and reprogrammable logic, an attacker may cause the defensive system to misinterpret input data, alter control flow, overwrite memory, suppress detection logic, or otherwise interfere with normal operation. In these scenarios, the malicious digital content may deactivate or evade the filter while being processed, allowing executable malicious code to pass through the defensive boundary undetected.

Second, a sanitized data stream must be isolated from digital code in a closed destination network which may combine with and manipulate the content to create executable malware. A sanitized data stream does not, by itself, preclude downstream systems from reinterpreting the sanitized characters as executable content. Thus, the sanitized data stream may function as a payload substrate that can influence program behavior when presented to or combined with an interpreter, parser, renderer, query processor, or similar execution-enabling subsystem within the closed network. Prior art does not address these two vulnerabilities, both of which may be eliminated to sanitize and protect content from malware. Taken as a whole, the present invention provides a technical solution that is not taught or suggested by the prior art and achieves advantages that are not attainable by conventional data-filtering or air-gap systems.

Specifically, Crane attempts to detect and remove malicious code from digital images and meta data by displaying on the open network side of an air gap digital images having meta data in text boxes overlayed on a live video image background and capturing the meta data and video images with a camera on the closed network side of the air gap. A still or video digital image consists of digital code which in addition to activating the pixels used to display the live video image and meta data, may manipulate background and character pixels to display obfuscated malicious code. For example, but not limitation, a QR code may not be detected by the firewalls in Crane and may be displayed in the background of the video image or as a machine-readable optical pattern embedded within the pixel structure of a rendered alphabetic character. When captured by an image sensor on the secure closed network side of the air gap the hidden QR code may inject malicious code into the closed network.

Displaying and capturing the analog character representation of an analog character that is a uniquely defined continuously variable visual glyph and is an element of a predefined character set known to both a display processor and a capture processor, is fundamentally different from capturing a character displayed as a configuration of pixels on a digital pixel background having the character and its background encoded together within a single pixel-based binary image. An analog character displayed as a continuously variable visual glyph is a single object not capable of transmitting digital data across an air gap, a digital character displayed as a pattern of pixels on a digital background is transmitting digital data across the air gap. With Crane and other current devices a reasonable threat exists that digital images contain malicious code obfuscated in digital backgrounds that may be captured and executed inside a secure closed network. The Crane patent represents a mobile live video display device for use in real time combat situations which has the limited functionality of applying antivirus algorithms to a data stream to successfully, or unsuccessfully, detect and remove malware. Crane does not block undetected and unknown malware.

Volino does not teach or suggest the use of an air gap or address the vulnerability of bypassing or deactivating digital defenses. Volino teaches optional deletion of data after, not before, the data is processed in a digital processor that is vulnerable to malware (Volino, Col. 16, line 67-Col. 17, lines 1-3: ‘Any various combinations of lines and other information can be left on or deleted depending[on] the choice of the operator creating the master document image’). Volino ‘ . . . is a system and method for the extraction of textual data from digital images using a pre-defined pattern of visible and invisible characters contained in the textual data’ (Volino, Col. 2, lines 30-34). Volino is an improvement on optical character recognition, a digital system executed by a digital electronic processor ‘ . . . the System can be comprised of a computer System being responsive to a program operating therein’ (Volino, Col. 7, Lines 22-24). If deletion is chosen by the operator, it is performed only after ‘the data was used to establish the patterns that are associated with each of the Zones that are used with the template that is associated with this master document image’ (Volino, Col. 17, lines 8-11). Volino does not teach or suggest prevention of execution of malicious code in digital data. By processing the data in a digital processing device before optional deletion, Volino is vulnerable to embedded malicious code in the data. Volino teaches the optional deletion of data to save resources and improve efficiency, deletion is not for the purpose of increasing data security.

Existing digital cybersecurity systems share the same vulnerabilities. Current methods and devices, including Crane and Volino, execute one or more steps of reading, interpreting, analyzing, and/or processing of digital data received from an open network utilizing digital data general-purpose processors and other software-modifiable computational devices before sanitizing the data, which may allow malicious code in the data to influence instruction selection, execution flow, and processor behavior. If current cybersecurity systems utilize air gaps they transmit data as digital signals or digital images across security barriers. Existing devices must detect and remove all malicious code to prevent the transfer of malicious code into a secure closed network.

Current methods and devices frequently fail to detect known, and cannot detect unknown, malicious digital code and may allow the manipulation and disabling of digital malware defenses. No current method or device extracts and transmits sanitized content across an analog air gap security barrier as isolated analog character representations, continuously variable visual glyphs, devoid of executable semantics. Inherent vulnerabilities in existing digital defenses to digital attacks are evidenced by the increase in data breaches from approximately 1000 per year in the early 2020's to over 3000 each year (Diana Elagina, Number of data compromises and impacted individuals in U.S. 2005-2024, Statista, 2026).

The present invention identifies and extracts digital content in a digital data stream received from an open network; deletes the remaining digital data which may contain malicious code; displays the extracted digital content as an analog character representation, a pictorial image, on a monitor or similar display apparatus located on one side of an air gap; captures the displayed pictorial image on the opposite side of the air gap; and optionally converts the pictorial image to a clean digital content file in a closed network. None of the current devices and methods, including Crane, are configured as a system with an immutable security-enforcement processing path that extracts digital content, discards all remaining digital data, converts the digital content to analog character representations of continuously variable visual glyphs, communicates the pictorial image of continuously variable visual glyphs across an analog air gap, and optionally converts the captured pictorial image into a clean digital content file or outputs the data in analog form.

Conversion of digital content into a pictorial representation on the sending side of an analog air gap and capture of the pictorial character representation on the receiving side allows clean content to pass across the analog air gap barrier, while blocking the passage of digital code. Unlike existing air gap systems, the present invention provides no transport mechanism by which malicious code can cross the analog air gap from an open network into a closed network.

There exists a need for systems and methods that ensure data entering a secure network environment is strictly sanitized using hardware that cannot be reprogrammed or compromised by the data itself and that communicates sanitized content across an analog air gap as analog character representations which are not executable.

### DEFINITIONS

Certain terms are expressly defined in this application to more precisely describe embodiments first disclosed herein. Unless stated otherwise, such definitions are intended to clarify and formalize the meaning of the terms as used throughout the present application.

The term ‘digital data’, as used herein, means information placed in a prescribed binary format represented by discrete and non-continuous binary values that is transmitted, processed, and/or stored in accordance with suitable protocols, and that is accessible through a logical data structure. For example, but without limitation, digital data may consist of information in digital binary format containing medical records, financial ledgers, corporate documents, commercial transactions, legal instruments, personally identifiable information, and/or any other information which is capable of being represented and encoded in a digital format.

Digital data is transmitted between network devices in the form of digital data streams sent over public and private networks. The term ‘digital data stream’, as used herein, means digital data transmitted as an ordered sequence of data from a source to a destination in accordance with one or more communication protocols. The terms ‘open network’ and ‘source network’, as used herein, designate a network which has limited security measures, for example the internet. For further example, but not limitation, distinguishing characteristics of an open network include less secure communication links with external networks; open ports allowing input and output of digital data; open physical access to computational devices; and minimal authentication of users. The terms ‘closed network’ and ‘destination network’, as used herein, describe a network which implements more stringent security measures and limits access to privileged users, like a private network used by a financial institution. For further example, but not limitation, distinguishing characteristics of a ‘closed network’ include secure or no communication links with external networks; closed or managed ports blocking input and output of digital data; restricted physical access to computational devices; advanced endpoint hardware and software defenses; and biometric authentication of users.

Digital data may be described as consisting of two components, content and code. The term ‘content’, as used herein, means information that may be used for business, personal, and/or other purposes and which is considered to be useful and not harmful to the individuals and entities. The term ‘digital content’, as used herein, consists of digitized information which may be used for business, personal, and/or other purposes and which is intended and/or considered to be useful and not harmful by the individuals and/or entities which create, utilize, and/or are otherwise authorized to access the digital information. For example, but not limitation, digital content may include, but is not limited to, digital representations of information using characters, words, sentences, numbers, symbols, drawings, photographs, and/or other objects capable of digital binary encoding, such as the stored text of an electronic book.

The second component of digital data, ‘code’, as used herein, refers to executable instructions or instruction sequences interpreted or executed by a computational device to control operation or define the operational behavior of the computational device. The term ‘digital code’, as used herein, consists of digital binary data into which digital content may be embedded and which serves as a formatting framework, medium for transport, instruction set, and/or other utilitarian purpose for the transport, processing, use, and/or storage of digital content. Executable digital code defines machine behavior, whereas digital content defines information conveyed to a user. For example, but not limitation, executable digital code governs the operation of a smartphone, whereas digital content comprises non-executable information stored, processed, or displayed by the smartphone. By way of further example, a weather forecast displayed by a news application is digital content produced through execution of digital code but is not itself executable code.

The terms ‘malicious code’ and ‘malicious digital code’, as used herein, include without limitation, malware, ransomware, denial of service attacks, and other digital code which when activated cause a targeted device or method to perform unauthorized, anomalous, and malicious behaviors. For example, but not limitation, while executable digital code governs the operation of a smartphone it cannot cause malicious behaviors in the absence of malicious digital code.

The term ‘embedded’, as used herein, is intended to convey in the broadest sense the presence of separate, distinguishable, digital objects as components of digital data. For example, but without limitation, digital content may be embedded in digital code which acts as a transport layer for the digital content, however the digital content remains a separable digital object which may be extracted from the digital code. The term ‘digital processor’, as used herein, describes a programmable computational device consisting of electronic circuitry that executes instructions in the form of digital code, such as a central processing unit in a computer. The term ‘digital filter’, as used herein, designates a digital processor device capable of recognition and extraction of digital objects embedded within other digital objects, for example, but not limitation, recognition and extraction of digital content embedded in a digital data stream.

The term ‘communication’, as used herein, describes the transport of information across an air gap in the form of analog data or a pictorial image. The term ‘transmission’, as used herein, describes the binary transport of information across an air gap in the form of digital data. As further clarification, analog data transferred across an analog air gap is communicated across the analog air gap, digital data transferred across an air gap is transmitted across the air gap. The term ‘obfuscation’, as used herein, should be understood to include all methods used to avoid or hinder recognition of malicious code, including but not limited to steganography.

The term ‘digital image files’, as used herein, describes digital data files which encode pictorial images of characters and/or other pictorial information captured by analog and/or digital image sensors; retain their format as pictorial images; and are stored in a digital image format (one example, the .png portable network graphics format), for example a photograph stored on a digital camera memory card. The terms ‘clean’ and ‘clean content’, as used herein, describes digital information obtained from analog pictorial characters when converted into digital data by the application of optical character recognition algorithms. The term ‘sanitized’ and ‘sanitized content’ refers to data extracted from a digital data stream and processed as valid content by the present invention. The terms clean, clean content, sanitized, and sanitized content are meant to identify data that has been processed and are not intended as assurance or guarantee that data does not contain malicious code or is no longer vulnerable to malicious code.

The term ‘clean content file’, as used herein, describes a digital file containing clean content.

The term ‘image sensor’, as used herein, comprises a physical sensing device that converts incident optical energy into electrical signals according to fixed physical and circuit characteristics.

The term ‘analog data’, as used herein, means data represented by a continuous physical range of values rather than by discrete numeric encodings. For example, without limitation, analog data may include soundwaves transmitted through air. As another example, handwritten characters on a sheet of paper constitute analog data, each character being expressed as a continuously variable visual form defined by physical characteristics including, without limitation, shape, size, and color.

The term ‘pictorial image’, as used herein, designates a visual representation of digital content, such as the alphanumeric text displayed on a computer monitor which is viewed as an analog visual object by the human eye. The term ‘pictorial character’, as used herein, designates the selection of a pictorial object as an element of a pictorial image for the purpose of communicating digital content, for example the letter ‘A’ when viewed on a display device as the visual object ‘A’. The term ‘defined pictorial character’, as used herein, designates the definition and/or creation of a pictorial object for the purpose of communicating digital content, for example a single character representing a letter or word (such as Chinese Hanzi). The term ‘pictorial information’, as used herein, is digital content in pictorial form which is not suitable or capable of conversion into pictorial characters, such as illustrations, photos, and handwriting. To accurately disclose the present invention, the image of a pictorial character and/or pictorial information when displayed on an analog monitor (one example, a CRT screen) or on a digital monitor (one example, an LCD screen) may be referred to herein as an ‘analog pictorial image’.

The term ‘character’, as used herein, means an individual letter, number, punctuation mark, or symbol, used to write or print a language. The term ‘digital character’, as used herein, means a character whose identity is uniquely specified by a discrete numeric or symbolic code value within a digital encoding system independent of any visual appearance used to render the character. For example, but without limitation, the letter ‘A’ is assigned the discrete numeric binary value 01000001 (decimal 65) within the ASCII digital encoding system. The term ‘visual form class’, as used herein, means a set of visually similar character representations that share sufficient common visual features to be recognized as instances of the same character despite variations in size, style, orientation, or other visual attributes.

An analog character constitutes a type of pictorial character as described in some embodiments, the pictorial object being recognized as a member of a visual form class of analog characters that maintains its identity across variations in visual attributes including shape, size, style, orientation, color, or proportion rather than by reference to a discrete numeric or symbolic code value within a digital encoding system. The term ‘continuously variable visual letterform’ refers to a shape representation of an analog character, while ‘continuously variable visual glyph’ refers to a broader graphical representation of the character, each constituting members of the visual form class of analog characters. For example, without limitation, the first letter of the alphabet may be rendered as an uppercase ‘A’ or a lowercase ‘a’ and may appear in different colors, shapes, sizes, or typographic styles while remaining perceptible as the same pictorial character. The term ‘analog character,’ as used herein, refers to a physically manifested or optically transmitted pictorial character that is a member of the visual form class and, in certain embodiments, corresponds to exactly one member of the predefined character set, thereby constituting an atomic symbol having a unique identity independent of its digital value and independent of any particular visual instance.

The terms ‘optical representation’ and ‘analog character representation’, as used herein, refer to an optical depiction of an analog character conveyed as a spatial visual pattern suitable for capture by an image sensor, image sensor, each depiction being an indivisible symbol matched to an identical member of the predefined character set rather than interpreted from pixels. Recognition of an analog character representation consists solely of determining membership in the predefined character set and does not include optical character recognition, feature extraction, pattern inference, decoding, or probabilistic classification. These terms do not alter the meaning of ‘pictorial character’ or ‘analog pictorial image’ in some embodiments, but provide additional terminology for embodiments in which a digital data stream is processed by immutable processors that extract digital characters encoding content, convert them to analog characters, and communicate them as analog character representations across an analog air gap as optical depictions lacking executable semantics. The term ‘atomic analog optical phenomena’, as used herein, means a continuous optical manifestation of a single character that does not encode discrete digital values.

The term ‘character set’, as used herein, means a group or collection of characters containing analog characters and corresponding digital characters having unique binary values defined prior to operation. The term ‘predefined character set’, as used herein, means a fixed, finite, closed collection of canonical characters, each canonically associated with (i) a corresponding digital value and (ii) a corresponding invariant analog character representation, all established prior to system operation and not modifiable by the received data stream, such that any valid analog character representation corresponds to exactly one member of the set by direct identity matching rather than interpretive analysis. For example, but not limitation, users may select the ASCII character set which assigns each character a unique binary value, known as an ASCII code, between 0 and 127. For further example, but not limitation, the ASCII code assigns decimal number 65 to represent the capital letter ‘A’, while decimal number 97 corresponds to the lowercase ‘a’. The term ‘predefined character set’, as used herein, means a fixed collection of characters established prior to processing and selected by the creator of the data stream or by system operators before the data stream is received by the system. The term ‘permitted characters’, as used herein, means any character that is a member of the predefined character set.

The term ‘computational device’, as used herein, means a machine, including but not limited to computers, smartphones, and IoT devices, that acquires, stores, and processes data, and performs mathematical operations and other functions based on instructions. The term ‘digital processor’, as used herein, refers to a programmable computational device consisting of electronic circuitry that executes instructions in the form of digital code, such as a central processing unit in a computer (CPU), microcontroller, or embedded processor.

The term ‘immutable processor’, as used herein, means a processor whose executable behavior is defined exclusively by non-modifiable hardware or non-alterable stored instructions fixed prior to operation and that, when provided identical input data, performs the same defined sequence of operations independent of externally supplied program code, configuration data, or runtime modification. An immutable processor defines an immutable processing boundary that encompasses data ingress, execution, and data egress under exclusive control of immutable microcode.

The term ‘photonic processor’, as used herein, refers to a programmable computational device consisting of photonic circuitry that executes instructions in the form of photonic code and that may input analog optical representations; perform operations on analog optical representations in the optical/photonic domain; and produce analog outputs.

The terms ‘read only memory’ (ROM), ‘write once read many’ (WORM), and ‘immutable memory’, as used herein, mean one time programmable memory and/or circuitry which after being manufactured or written once may be read cannot be modified, rewritten, altered, or otherwise changed. For example, but not limitation, fixed logic circuitry executing code in a remotely controlled LED light bulb which executes deterministic cycles.

The term ‘immutable instructions’, as used herein, means executable instructions and sets of instructions stored in read only memory, immutable memory, or fixed logic circuitry, the instructions not being capable of modification after being written once. The terms ‘scripts’and ‘immutable scripts’, as used herein, mean immutable instructions and sets of immutable instructions which are predefined to deterministically evaluate arrays of sanitized character data to identify valid content in context and to cause output of arrays of bytes determined to contain valid content in context and deletion of arrays determined not to contain valid content in context. User selection or provision of scripts occurs prior to fixation of the immutable instructions, after which the scripts cannot be modified, replaced, or supplemented.

The term ‘digital air gap’, as used herein, designates an air gap across which information in the form of digital data is transmitted in one direction only from a sending device to a receiving device, for example, but not limitation, an air gap where a digital data stream is transmitted utilizing digital diodes. The term ‘analog air gap’, as used herein, designates an air gap across which information in the form of a pictorial image is communicated in one direction only from a sending device to a receiving device and where the information is not transmitted as digital data, for example an air gap where a pictorial image is displayed on a monitor on the sending side and captured by an optical lens and camera on the receiving side of the air gap. As further clarification, the term analog air gap means an air gap that permits only communication of analog data across the air gap, wherein the communicated information exists exclusively as continuously variable physical representations of content, including analog character representations as defined herein, and such embodiments operate without reliance on discrete digital value encoding across the air gap, digitally modulated signals, or binary-encoded data structures.

The term ‘input boundary’, as used herein, refers to the point at which source data first enters the disclosed invention exclusively by direct receipt into the character filter immutable processor, with no intervening executable processing elements. The term ‘output boundary’, as used herein, refers to a defined interface, transition point, or termination point, typically but not limited to a digital diode enforcing one-way communication, at which the disclosed invention produces, exposes, or makes available an output generated by the invention for receipt by an external system.

### SUMMARY OF THE INVENTION

Existing air gap devices and methods which transfer digital data from an open network to a closed network embed the digital content in digital code, which acts as a transport mechanism for the digital content across the air gap and/or verification of successful transmission (one example, but without limitation, use of bidirectional checksum comparison of data in the closed network and the open network). The transmission of digital code across a digital air gap introduces the risk of exposure to transmission of malicious code, denial of service attacks, system corruption, and/or data loss into the closed network.

The present invention takes a fundamentally different approach than current devices and methods, which must be capable of recognizing malicious code to prevent malicious behaviors. Instead of attempting to identify and extract malicious code from digital data, the present invention recognizes and extracts digital content; deletes the remaining digital data; displays a pictorial representation of the digital content on a display device on one side of an analog air gap; captures the pictorial image of the content on the opposite side of the analog air gap; and in the case of digital content which is capable of representation as alphanumeric or other pictorial characters, optionally uses optical character recognition algorithms to convert the captured pictorial images to a digital clean content file in a secure closed network. Digital content which is not capable of representation as alphanumeric or other pictorial characters, such as illustrations, may be captured by a separate digital processor device and stored as digital image files. In additional embodiments, the digital data stream is processed exclusively by immutable processors executing immutable instructions, extracting digital characters encoding content, converting them to analog characters, and communicating them across an analog air gap as analog character representations lacking executable semantics; and optionally outputting the data as non-executable digital characters or analog photonic characters to a closed network.

The digital content in business documents; personally identifiable information protected by HIPAA (the Health Insurance Portability and Accountability Act), GDPR (General Data Protection Regulation), and other governmental regulation; credit card PCI data; numerical transactional records; and other similar digital content is typically encoded as binary alphanumeric and/or other characters which may be extracted and converted into pictorial characters. Pictorial information in digital content, such as illustrations and pictures, may be included in a data stream to visually describe the digital content represented by pictorial characters. Such pictorial information in many cases may be duplicative and/or explanatory of the pictorial characters and may be deleted without negatively affecting the intended communication of the information in the source digital data stream.

In preferred embodiments of the present invention, source data is received from an open network and processed by a dedicated digital processing device executing algorithms which recognize digital content, such as human readable text in documents and numeric characters representing quantity or price in commercial transactions. With the prior consent of the individuals and/or entities providing the digital data stream, other forms of digital content, if any, are deleted with the remainder of the digital data stream. In some embodiments, but only optional preprocessing outside the immutable path in preferred embodiments, algorithms may include artificial intelligence and machine learning code to improve recognition of digital content in the source digital data stream.

The extracted digital content is displayed by a dedicated digital processor device as a pictorial image on a dedicated display device located on one side of an analog air gap, for example a computer monitor, utilizing selected alphanumeric and/or other defined pictorial characters. For example, but without limitation, when a digital tablet is used as a book reader the image of a page of a book that is displayed is a pictorial representation of the page stored in the device's digital memory and is viewed by the reader's eyes as a visual pictorial image. In some embodiments the characters which are selected to pictorially represent the digital content are chosen based on knowledge of the nature of the digital content contained in the data stream. In some embodiments the display device may be physically capable of and/or programmed to display only the selected alphanumeric and/or other defined pictorial character set by physically and/or programmatically disabling pixels not necessary for the display of the character set.

The analog pictorial image of alphanumeric and/or other defined characters displayed on the sending display device is received and captured by a dedicated processor device containing an image sensor, located on the opposite side of the analog air gap, which is capable of recording pictorial images, for example an optical lens and image sensor similar to a digital camera. The digital processor device encodes the pixel patterns on the sending display in a similar manner as a photograph taken by a digital camera and may be physically capable of and/or programmed to capture only the selected alphanumeric and/or other defined pictorial character set. The analog pictorial image is converted to a digital image file (for example, a .png portable network graphic file) for further processing. In some embodiments the analog to digital conversion device may be physically capable of and/or programmed to only convert from analog to digital the selected alphanumeric and/or other defined pictorial character set.

The digital image file is processed by the digital processor device to remove unwanted digital artifacts such as aliasing. The pictorial representation of digital content contained in the digital image file is parsed using optical character recognition algorithms to convert and encode the digital images as binary digital representations of the characters, which are recorded as clean digital content in a digital content file. In some embodiments, the optical character recognition algorithms may utilize artificial intelligence and machine learning methods to improve the accuracy of the recognition and conversion of digital images and to warn of the possible use of anomalous content which could indicate the use of steganography to obfuscate malicious code. For example, but without limitation, an alphanumeric word might be flagged for review if it was nonsensical or had an unusually large number of characters.

In other embodiments, digital content which can be represented by pictorial characters is converted into pictorial characters; processed in the same manner as in the preferred embodiments; and stored as clean content files. Digital content which cannot be represented by pictorial characters is displayed as a pictorial image on the sending side of the analog air gap; captured as analog pictorial images on the receiving side; recorded as a digital image file; and stored along with an index linking and synchronizing the digital image file with any clean digital content files extracted from the same source digital data stream.

Furthermore, the present invention is superior to current devices and methods in the verification of accuracy of digital content transmitted and/or communicated across an air gap. Transmission of an alphanumeric character over a digital air gap is typically accomplished by current devices sending each encoded character as a serial transmission of between 8 and 32 digital bits. If significant bits representing the digital characters are not correctly sent and/or received, the receiving device misreads the characters. To verify correct transmission of a digital character sent across a digital air gap, such as a digital diode air gap, some form of algorithm must be employed, such as utilizing error correcting code, multiple transmission of the same character, and/or bidirectional communication. Existing verification methods reduce the transmission rate of digital data and/or introduce the risk of bidirectional transmission of malicious code and protected data between an open and closed network.

The present invention's error rate is superior to existing devices and methods. The analog nature of the pictorial characters provides parallel optical communication of multiple pixels comprising each character which may be captured by a sensor and accurately converted to digital content by optical character recognition algorithms even if a percentage of pixels or other data points comprising the character are missing or corrupt. Pictorial representation of characters and other digital content eliminates the need for bidirectional comparison and/or other verification of information crossing an air gap. The display and optical capture of pictorial images of digital content assures, with a statistical certainty exceeding existing methods, that digital content in the closed network is an identical copy of digital content received from the open network.

The present invention produces clean digital content which does not contain malicious code and/or other executable malicious code vectors. The clean content (i.e., content lacking executable structure) is protected and stored in a closed network, typically located within a secure digital data facility which is isolated from cyberthreat vectors. The present invention is superior in that it prevents transmission of malicious code, denial of service attacks, system corruption, data loss, and/or access to the clean digital content by cybercriminals, including access to protected personally identifiable information (PII) such as medical data protected under HIPAA statutes.

In accordance with the additional embodiments, execution of all processing operations on the open and closed network sides of the analog air gap are performed by immutable processors executing immutable instructions. An immutable processor lacks any capability for post-manufacture modification of executable behavior and executes only deterministic instructions stored in immutable memory or fixed logic circuitry. As a result, for any given input data execution follows a predetermined sequence of operations and produces a predictable result that cannot be altered by input data, external control, or runtime modification. This architectural constraint substantially reduces the attack surface by eliminating writable instruction memory, self-modifying execution paths, dynamic code interpretation, and other non-deterministic operations thereby preventing untrusted input data from influencing processor behavior beyond the deterministic processing explicitly defined by the immutable instructions.

In the disclosed architecture multiple immutable processing stages consisting of multiple steps are arranged to sequentially filter, contextualize, and render digital character data as analog characters for unidirectional communication across an analog air gap. Immutable processors strictly separate executable behavior from data processing, extracted characters are treated solely as content and are not interpreted, dispatched, or executed as instructions. Because immutable processors lack instruction fetch or decode paths that process input data, malicious or malformed data cannot acquire executable semantics or influence instruction selection. This implementation ensures predictable behavior and resistance to code execution. This separation is particularly advantageous when processing data originating from untrusted or open networks.

Immutable processors executing immutable instructions are particularly well suited for air-gapped and high-assurance computing environments. By constraining execution behavior to immutable logic and immutable instruction storage, the architecture ensures that information communicated across an analog air gap is derived exclusively from predetermined processing operations and not from dynamically executed code. This property supports unidirectional information transfer while preventing covert execution and unintended propagation of malicious code.

In accordance with additional embodiments, the sanitized digital characters extracted from the incoming digital data stream are converted into analog character representations prior to communication across an analog air gap. While the distinction between individual analog characters which belong to the visual form class having continuously variable characteristics such as font, color, and size, and digital pixel representations of alphanumeric characters may not be immediately obvious, it should be appreciated that the character filter guarantees that only digital characters are output by the character filter to the context filter that have analog characters corresponding to the extracted binary values. Each digital character output by the character filter has a one-to-one correspondence to a single analog character, and that analog character may have many analog character representations uniquely identifiable to the character. The individual analog characters are conveyed across the analog air gap solely as analog character representations, continuously variable visual glyphs, which are physical continuously variable optical representations of the analog characters, rather than as binary-encoded digital data. As a result, no executable instructions, digital control structures, or machine-interpretable code is transmitted across the analog air gap. The analog character representations convey human-interpretable content while inherently lacking the discrete binary structure required for instruction fetch, decode, or execution on the receiving side of the analog air gap.

Specifically, conversion of digital characters into analog character representations prior to air-gap communication separates informational content from executable semantics. While a digital character encoded as a binary value may be interpreted as data or, under certain conditions, as part of executable code, an analog character displayed as an analog character representation lacks any discrete binary encoding and therefore cannot be interpreted, dispatched, or executed by digital logic. The receiving side of the analog air gap lacks machine-interpretable structure within the receiving system as configured for interpreting the communicated analog character representations as executable instructions, regardless of the content or arrangement of the characters.

Extracting and converting digital content into individual pictorial characters on the open network side of an analog air gap and capturing the discrete pictorial characters on the closed network side results in clean sanitized content crossing the analog air gap, while blocking the passage of digital code. A hypothetical may help clarify and distinguish the method and devices in the present invention. Assume two people are on opposite sides of a room, a presenter and an observer, each having a box containing cards with the letters from A to Z. Every letter has a sequential number on the back of the card, 1 for A to 26 for Z. The presenter receives a digital message in a digital data stream sent from a third person containing content in the form of text using the numeric values of the letters A to Z, along with benign code and malware. The presenter wants to safely communicate the text to the observer. The presenter looks at the numeric value of the next digital byte in the digital data stream, if it is 0 or greater than 26, they delete the byte. This is a critical step, if the numeric value in the digital data stream does not match any numbers on the character cards in the presenter's box it is discarded, there is nothing in the presenter's box capable of communicating the deleted digital byte across the room.

If the numeric value of the next byte in the digital data stream is between 1 and 26 the presenter searches through their box to find the card having that number. For example, if the numeric value of the byte is 3 the presenter finds the character C and places it on a table. The process continues until the presenter has placed a series of cards sufficient for the presenter to determine that the cards either represent content in context or do not represent content. For example, If the series of letters is E X E and the context is types of animals, the presenter determines that EXE is not content in that context and discards the three cards. If the series of cards is C A T the presenter determines that CAT is valid content in context and then holds up each individual card starting with C. The observer sees the letter C being held up, finds a matching letter C in their box with a number 3 on the back, and optionally inputs the binary number 3 into a digital data file or places the letter C on their table. The process repeats until all the valid content has been communicated as a series of discrete letters, in this case CAT. If a third party chooses to receive a digital file from the observer they are given the digital file containing 3-1-19 or if they choose to receive an analog version they are handed the three cards with the letters C-A-T. It is important to note that only characters from A to Z can cross the room from the presenter to the observer, it is physically impossible for any other characters to be communicated between the presenter and the observer. Preferred embodiments of the present invention implement steps similar to those taken by the presenter and observer in five stages.

The first stage, an incoming digital data stream is input by a character filter executing a first set of immutable instructions in a first immutable processor, comparing the binary value of each byte in the order it is received with binary values in a predefined character set, deleting the byte if it does not correspond to a binary value in the character set or if it does correspond extracting the byte and outputting it to a second memory buffer. Immutable instructions and scripts are organized into sets and stored in immutable memory, each set being configured and coupled to an associated immutable processor.

The second stage is analyzing by a context filter executing a second set of immutable instructions in a second immutable processor an array of predefined length formed from the bytes accumulated in the second memory buffer and deleting the array if it does not represent content in context or if it does represent content in context outputting the array to a third memory buffer.

The third stage is converting in a display module by a third immutable processor executing a third set of immutable instructions each byte in the third memory buffer into the analog character in the predefined character set corresponding to the binary value of the byte and displaying an analog character representation of the analog character on a display positioned on the open network side of the analog air gap.

The fourth stage is capturing by an image sensor positioned on the closed network side of the analog air gap, the analog character representation and storing the captured analog character representation in a fourth memory buffer processor on the closed network side of the analog air gap. The image sensor operates as a functionally immutable transduction element whose output is determined solely by incident optical input and fixed physical properties. The image sensor therefore does not constitute a processing stage and does not break the immutable processing boundary defined by the immutable processors.

The fifth stage provides two mutually exclusive options processed by a fourth immutable processor executing a fourth set of immutable instructions in the image processing module, (a) a conversion mode which converts each captured analog character representation into the binary value corresponding to the analog character in a predefined character set and outputs the binary value of the byte to a subsystem external to the apparatus configured to process and store characters as sanitized digital data, the subsystem being configured to treat the binary value exclusively as non-executable data in a data only context isolated from any instruction execution logic, or (b) a retention mode in which the image processor causes the captured analog character representations in the fourth memory buffer to be retained in analog form without generating a binary value and communicates captured analog character representations to a subsystem external to the apparatus configured to receive and process optical or photonic representations of analog characters without converting the analog characters into binary digital data.

### BRIEF DESCRIPTION OF THE DRAWINGS

FIG. 1 illustrates a one-way data communication system of digital content according to preferred embodiments of the present invention.

FIG. 2 illustrates a one-way data communication system of digital content according to some embodiments for communicating data across an analog air gap from an open network to a closed network.

FIG. 3 illustrates a one-way data communication system of digital content according to some embodiments for communicating data across a protected analog air gap into a protected data facility from an open network to a closed network.

FIG. 4 illustrates the use of two receiver devices on the closed network of the one-way data communication system of FIG. 3.

FIG. 5 illustrates the use of two data displays on the sender device on the open network and two receiver devices on the closed network of the one-way data communication system of FIG. 4.

FIG. 6 illustrates the use of two data displays on the sender device on the open network and two receiver devices and two digital diodes contained in separate areas on the closed network of the one-way data communication system of FIG. 4.

FIG. 7 illustrates the use of two data displays on the sender device on the open network and two receiver devices and three digital diodes contained in two separate areas on the closed network of the one-way data communication system of FIG. 4.

FIG. 8 illustrates a modular and/or mobile configuration for the one-way data communication system of digital content according to some embodiments for communicating data, across a protected analog air gap from an open network to a closed network of FIG. 3.

FIG. 9 illustrates the one-way data communication system of digital content according to some embodiments for communication and storage of data, across a protected analog air gap from an open network to a closed network of FIG. 3.

FIG. 10 illustrates a one-way data communication system according to some embodiments for communicating digital content across an analog air gap from an open network to a SaaS database on the closed network of the one-way data communication system of FIG. 2.

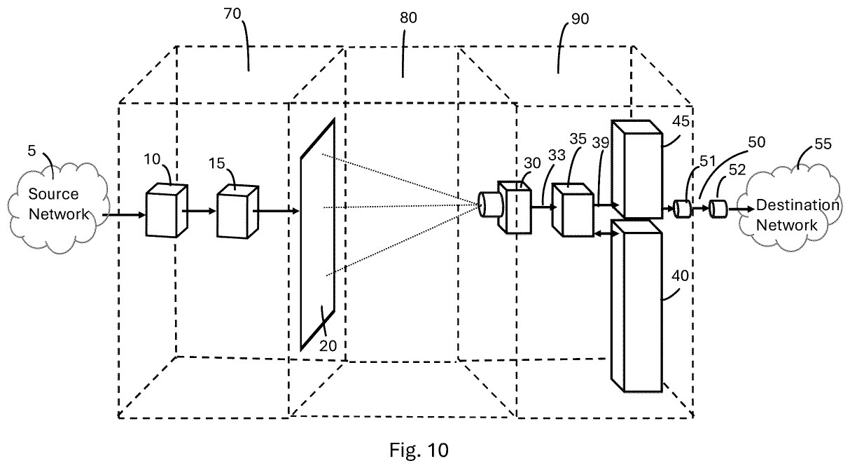

FIG. 11 is a schematic view of the transmission of individual character data across an air gap.

FIG. 12 is a schematic view of the transmission of content in context across an air gap.

### DETAILED DESCRIPTION OF THE INVENTION

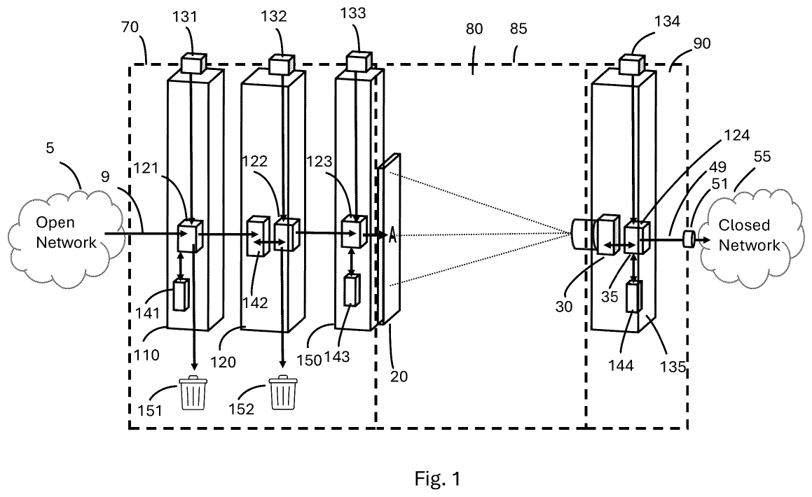

FIG. 1 illustrates a preferred embodiment, wherein the digital data stream is processed exclusively by immutable processors executing immutable instructions, extracting digital characters encoding content, converting them to analog characters, and communicating them across an analog air gap as analog character representations lacking executable semantics, and optionally outputting the data as non-executable digital characters or analog photonic characters to a closed network.

Referring to FIG. 1, the preferred embodiments include an apparatus and method for processing and sanitizing an incoming digital data stream 9 from an open network 5, continuously performing steps of:
(a) receiving a digital data stream 9 from the open network 5 at a first immutable processor, also called the character filter immutable processor 121, which is in a character filter 110, executing a first set of immutable instructions stored in first immutable memory 131 coupled to the character filter immutable processor 121;
(b) reading, by executing the first set of immutable instructions stored in first immutable memory 131 in the character filter immutable processor 121, each received byte and placing the byte in a first memory buffer 141 in the order in which the bytes are received, maintaining sequential ordering of bytes and the characters they represent throughout all steps;
(c) comparing, by executing the first set of immutable instructions stored in character filter immutable memory 131 in the first immutable processor 121 in the character filter 110, the binary value of the byte with binary values in a predefined character set stored in first immutable memory 131;
(d) deleting 151, by executing the first set of immutable instructions stored in first immutable memory 131 in the character filter immutable processor 121, the byte in response to determining that the binary value of the byte does not correspond to any binary value of characters in the predefined character set stored in first immutable memory 131;
(e) outputting, by executing the first set of immutable instructions stored in first immutable memory 131 in the character filter immutable processor 121, the byte to a second memory buffer 142 in a context filter 120 in response to determining that the binary value of the byte corresponds to a binary value of a character in the predefined character set stored in first immutable memory 131;
(f) repeating, steps (a)-(e) for each byte in the digital data stream until each byte has been deleted or output to the second memory buffer 142;
(g) analyzing, by a second immutable processor, also called the context filter immutable processor 122, which is in the context filter 120, executing the second set of immutable instructions including immutable context scripts stored in second immutable memory 132 coupled to the context filter immutable processor 122 an array of predefined length formed from bytes accumulated in the second memory buffer 142 and determining whether the array represents content in context;
(h) deleting 152, by executing the second set of immutable instructions and immutable context scripts stored in immutable memory 132 in the context filter immutable processor 122, the array in response to determining that the array does not represent content in context;
(i) outputting, by executing the second set of immutable instructions and immutable context scripts stored in second immutable memory 132 in the context filter immutable processor 122, the array to a third memory buffer 143 in a display module 150 in response to determining that the array represents digital content in context. For example, but not limitation, while the letters ‘v’, ‘i’, ‘r’, ‘u’, ‘s’, are all valid individual characters, in certain configurations of the content filter executing certain scripts the array ‘virus’ may be flagged as non-content, potentially malicious, and deleted while arrays deemed to represent valid content in context are output to the display module 150;
(j) converting, by a third immutable processor, also called the display module immutable processor 123 in the display module 150 executing a third set of immutable instructions stored in third immutable memory 133 coupled to the display module immutable processor 123, each byte in the third memory buffer 143 into the analog character in the predefined character set corresponding to the binary value of the byte;
(k) displaying 20, by executing the third set of immutable instructions stored in third immutable memory 133 in the display module immutable processor 123, analog character representations corresponding to the analog characters in the third memory buffer 143 on a display 20 positioned on the open network side 70 of the analog air gap 80;
(l) capturing, by an image sensor 30 positioned on the closed network side 90 of the analog air gap 80, the analog characters representations and storing the captured analog character representations in a fourth memory buffer 144 in an image processing module 135;
(m) processing, at a fourth immutable processor, also called the image processing immutable processor 124 in the image processing module 135 executing a fourth set of immutable instructions including a copy of the predefined character set stored in fourth immutable memory 134 (corresponding to the predefined character set in first immutable memory 131) and coupled to the image processing immutable processor 124, the processing comprising either:
(m1) converting each analog character representation in the fourth memory buffer 144 into the binary value in the predefined character set 134 corresponding to the analog character representation, or
(m2) retaining the captured analog character representations in analog form in the fourth memory buffer 144 without generating any binary values;
(n) outputting 49, in response to step (m1), the binary values of the bytes stored in the fourth memory buffer 144 to an external subsystem configured to process and store characters as sanitized digital data, the subsystem being configured to treat the binary values exclusively as non-executable data in a data-only context isolated from any instruction execution logic; or
(o) communicating 49, in response to step (m2), the captured analog character representations stored in the fourth memory buffer 144 to an external subsystem configured to receive analog character representations for storage in analog form or for processing in an analog domain, the external subsystem being configured to process analog character representations without conversion into binary digital data.

The preferred embodiment or the present invention are configured such that all steps (a)-(o) are performed continuously as new bytes are received; immutable processors 121, 122, 123, and 124 are incapable of executing instructions other than the immutable instructions stored in immutable memory coupled to the associated processor; copies of the predefined characters set may be included in the second 132 and third 133 instruction sets; there are no mutable, reprogrammable, or software-defined processing elements on the open-network side or closed network-side of the analog air gap; and unidirectional communication across the analog air gap 80 excludes any transmission of binary encoded digital data and consists solely of analog character representations. Immutable processors 121, 122, 123, and 124 are capable of executing multiple sets of instructions, so for example, immutable processor 121, the character filter immutable processor is capable of executing immutable instructions to receive the digital data stream 9 from the open network, instructions to read each received byte and place it in the first memory buffer 141, then instructions to compare each byte with the bytes from the predefined character set, then instructions to delete the bytes that do not correspond to the bytes from the predefined character set, and finally to follow the instructions to output the remaining bytes to the context filter 120.

A distinguishing feature of the present invention is that in all such embodiments, every device, module, circuit, and processing operation located on the open-network side and closed-network side of the analog air gap is immutable by construction. The open-network side and closed-network side of the analog air gap do not include general-purpose processors, writable program memory, firmware update mechanisms, interpreters, just-in-time compilers, microcode update paths, or any other circuitry capable of altering executable behavior in response to received data. All data processing performed in the embodiments is executed exclusively by immutable processors 121, 122, 123, and 124 executing sets of immutable instructions stored in immutable memory 131, 132, 133, and 134, such that neither the processors nor the instructions can be modified, replaced, updated, or reprogrammed during operation or after deployment. Because all processing is performed by immutable processors executing sets of immutable instructions, no data received from the open network can influence, alter, disable, bypass, or reconfigure the processing logic itself, including by malformed input, obfuscated instruction sequences, or zero-day exploits targeting software-defined defenses.

Preferred embodiments (FIG. 1) are configured and operate as an immutable data transformation pipeline rather than a communication channel. The immutable pipeline constrains the system to a one-way semantic reduction: the open-network side reduces arbitrary digital input to permitted analog characters only and the closed-network side transforms captured depictions into output data using fixed image operations that do not execute or reconstruct executable content. From the input boundary of the character filter 110 at the first immutable processor 121 to the output boundary of the system 51 in image processing module 135, data is processed in a strictly deterministic manner in which each byte is handled as an isolated data element. The term ‘digital character’, as used herein, means a character whose identity is uniquely specified by a discrete numeric or symbolic code value within a digital encoding system independent of any visual appearance used to render the character. All open-network processing is performed by immutable processors executing immutable instructions, no data received from the open network can influence, alter, disable, bypass, or reconfigure the processing logic itself, including by malformed input, obfuscated instruction sequences, or zero-day exploits targeting software-defined defenses.

Each byte, or each byte within an array of bytes, is individually subjected to fixed transformation rules implemented by immutable processors. The processed data cannot alter the processing sequence, execution path, or operational state of any module. No transport protocol, command interpretation, or state negotiation occurs between modules. Instead, raw bytes are passed directly from the buffer of one immutable processor to the next. Where arrays of bytes are evaluated by scripted analysis in the context filter 120, each byte in the array is analyzed as data only and not as executable instructions. Consequently, the processing performed by the system is entirely predetermined and invariant for a given input sequence. Each byte propagates through a fixed sequence of operations, and identical input byte sequences always produce identical output results.

The immutable processing path establishes two enforced transformation boundaries. At the open-network side, the character filter 110 and context filter 120 convert the incoming digital data stream into members of the permitted analog character set only, such that any data not corresponding to a valid analog character is deleted and cannot influence the displayed depiction. Accordingly, the display device is structurally limited by the third immutable processor 123 to presenting optical depictions of analog characters and cannot present executable digital content. For example, but not limitation, each individual byte is received from the digital data stream at the first immutable processor 121 in the character filter 110 and processed before the next byte is input. The processor does not implement a network interface, session state, or protocol stack. Instead, it sequentially inspects individual byte values presented at its input and treats each value only as data, not as a command, instruction, or structured message element. Accordingly, the meaning of the data within any external communication protocol is irrelevant to system operation. The first immutable processor 121 executes the purely deterministic process of reading the binary value of each byte, compares the binary value to the binary values of characters in a predefined character set, and either deletes the byte if there is no corresponding binary value in the predefined set or outputs the byte to the context filter 120. The preferred embodiments (FIG. 1) are configured such that no character is obtainable at the output boundary (digital diode 51) unless derived from a byte accepted by the first immutable processor 121 in the character filter 110 and retained by the second immutable processor 122 in the context filter 120. Bytes output by the first immutable processor 121 and the analog characters corresponding to those bytes, which are not deleted by the context filter 120, are the only characters made available at the output boundary.

It should be noted that an immutable processor executes immutable microcode and does not fetch, load, or derive executable instructions from any external memory, firmware storage, boot media, or support components. Upon application of power or reset, the immutable processor begins execution solely from its internally embodied immutable microcode and advances processing through a deterministic sequence of instruction steps defined entirely by the physical microcode circuitry. The internal immutable microcode governs instruction sequencing, control flow, branching behavior, and state transitions, and remains in complete control of processing irrespective of input data values. Input data is treated exclusively as data and may influence only data-dependent outcomes of the predetermined instruction sequence, but cannot alter instruction selection, instruction ordering, control flow, branching logic, or executable semantics of the immutable processor. The immutable processor lacks any capability for post-manufacture or post-deployment modification of executable behavior, including modification via firmware updates, microcode patching, reset-vector redirection, or external instruction sources.

The immutable processors 121, 122, 123, and 124, operate independently of any communication protocol and process incoming data strictly as a sequential stream of bytes. Each byte is read and processed in the order in which it is received, without regard to protocol framing, message structure, packet boundaries, or associated metadata. Where necessary, the processors may enter wait states to preserve strict sequential ordering, such that no byte received later in time is processed or emitted ahead of a byte received earlier. For example, but not limitation, if bytes corresponding to the letters C A T are received in that order, the word CAT, if validated as content in context, would sequentially be output from the system with no possibility of transposition of letters.

The character filter 110 operates to deterministically select permitted characters from an incoming digital data stream without interpreting, decoding, or executing the data stream as instructions or content. The character filter 110 processes the source digital data stream strictly as an ordered sequence of bytes, and for each byte performs a fixed, predefined comparison against a predefined character set. If, and only if, the binary value of the byte exactly matches one of the binary values in the predefined character set, the byte is selected for output; otherwise, the byte is deterministically deleted 151. The selection decision for each byte is independent of surrounding bytes, prior data, data context, or any inferred meaning of the data stream. The character filter 110 does not perform semantic interpretation, instruction decoding, compression, decompression, or transformation of the byte values. Accordingly, the output of the character filter 110 consists solely of those bytes whose binary values correspond to permitted characters, in the same order in which the bytes were received.

The character filter 110 executes the same sequence of operations for every received byte, regardless of the source, content, or structure of the incoming digital data stream. Given the same predefined character set and the same ordered sequence of input bytes, the character filter 110 will always produce the same ordered sequence of output bytes. No state, learning, heuristic, or adaptive behavior influences the selection process. Because the character filter 110 performs only deterministic selection based on exact binary comparison, it cannot be induced to output bytes that are not members of the predefined character set, nor can it be induced to alter its selection behavior in response to specially crafted input. Bytes corresponding to permitted characters are propagated as individual characters independent of surrounding data in the incoming stream. This deterministic operation ensures that executable code, control structures, and instruction encodings that rely on byte values outside the predefined character set are irreversibly removed prior to any subsequent processing or transfer across the analog air gap. Thus, the character filter 110 functions as a deterministic, non-interpretive selector that irreversibly removes all bytes not corresponding to predefined character values, ensuring that only sanitized character data is retained for subsequent processing. Following filtering, each extracted character is propagated in sequential order as an independent atomic symbol.

A predefined character set consists of a set of characters, for example, but not limitation, alphanumeric analog characters ‘A’ through ‘Z’, ‘a’ through ‘z’, and numbers ‘0’ through ‘9’, with each analog character being assigned a corresponding digital character having arbitrary binary value to allow transmission as digital data, typically in binary format, in a digital data stream. While arbitrary non-standard digital characters and numeric values corresponding to the analog characters they represent can be used for security purposes, the vast majority of digital characters used in modern computing systems are not arbitrary symbols, but are standardized representations defined by international and national standards bodies to ensure consistent interpretation across disparate hardware, software, and communication systems. Organizations such as the American National Standards Institute (ANSI), the Unicode Consortium, and other international standards groups including the International Organization for Standardization and the International Electrotechnical Commission have established numeric code points that correspond to defined alphanumeric characters, symbols, and other continuously variable visual glyphs. Under these standards, each character is assigned a specific binary value that uniquely identifies that character independent of font, language, display technology, or computing platform. This standardization allows digital systems to encode, transmit, store, and reproduce textual information as standardized digital representations corresponding to analog characters in a predictable and interoperable manner.

The primary purpose of character standardization is to enable reliable communication and interpretation of symbolic information across heterogeneous digital systems, networks, and devices. By defining fixed numeric identifiers for characters, these standards eliminate ambiguity in how symbolic content is represented digitally and ensure that identical numeric sequences correspond to the same human-interpretable characters across systems. Importantly, such standardization establishes a boundary between (i) digital representations, which exist as discrete binary values interpretable by a computational system; (ii) analog characters, whose identity is determined by human-recognizable visual form; and (iii) analog character representations, which comprise physically manifested or optically transmitted continuously variable glyphs that convey the identity of the analog characters across an analog air gap using visible or non-visible optical wavelengths, provided the conveyed information remains perceptible only as visual form rather than as digitally encoded data. The embodiments disclosed herein leverage this distinction by converting standardized digital character values into analog character representations that preserve semantic meaning while preventing transmission of executable digital data across the air gap, thereby enabling secure, human-interpretable data transfer without preserving the computational properties inherent in the standardized digital encodings. As used herein, standardized digital character values are treated solely as symbolic identifiers for analog characters and are not interpreted, processed, or transferred in a manner that preserves instruction semantics, executable behavior, or computational control across the air gap.

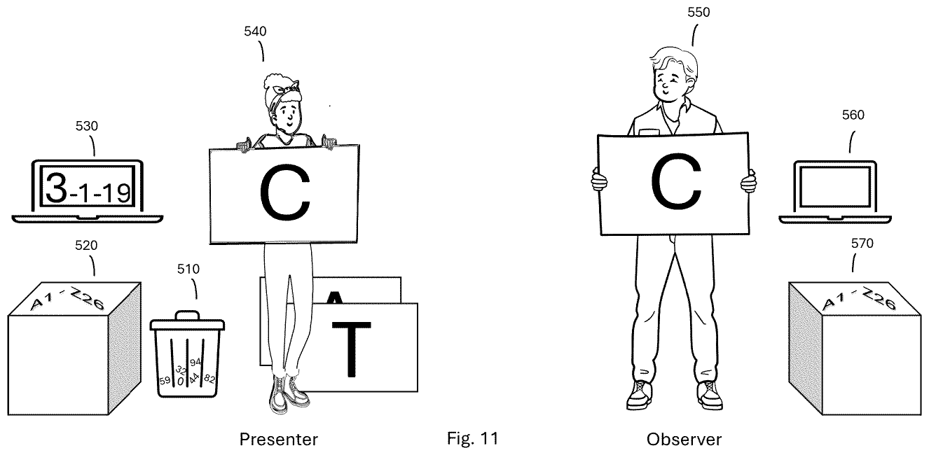

Extracting and converting digital content into individual pictorial characters on the open network side of an analog air gap and capturing the discrete pictorial characters on the closed network side results in non-executable content crossing the analog air gap, while blocking the passage of digital code. A hypothetical may help clarify and distinguish the method and devices in the present invention. Referring to FIG. 11, assume two people are on opposite sides of a room, a presenter 540 and an observer 550, each have a box 520 and 570 containing a large number of cards with one letter from A to Z written on them. Every letter has a unique identifying number on the back of the card that corresponds to the letter on the card, 1 for A, 2 for B, . . . to 26 for Z. The presenter receives a digital message 530 in a digital data stream from a sender on an open network containing numeric values for the letters A to Z, along with benign code and malware. The presenter 540 wants to safely communicate the text message to the observer 550. The presenter looks at the numeric value of the first digital byte in the digital data stream, if it is 0 or greater than 26, they delete 510 that byte. This is a critical step, if the numeric value in the digital data stream does not match any numbers on any of the character cards in the presenter's box it is discarded, there is nothing in the presenter's box 520 capable of communicating the deleted digital byte across the room.

If the numeric value of the byte in the digital data stream is between 1 and 26 the presenter searches through their box to find the card having that number. For example, if the numeric value of the byte is 3 the presenter finds the character C and places it on a table. The process continues until the presenter has placed a series of cards sufficient for them to determine that the cards represent content in context or do not represent content in context. For example, but not limitation, assume the context of the message is animals. If the observer receives the numbers 34-28-40 the bytes are deleted 510 as not representing any of the letters A-Z in the presenters box. If the bytes are 5-25-5 the letters are E-X-E which are not content in context and the three cards are put back in the box 520, but if the next three bytes are 3-1-19 the presenter determines that C-A-T is valid content in context and holds up each individual card starting with C. The observer 550 sees the letter C being held up, finds a matching letter C in their box 570, and places the letter on their table. The process repeats until all the valid content has been communicated to the observer as a series of discrete letters, in this case C-A-T.

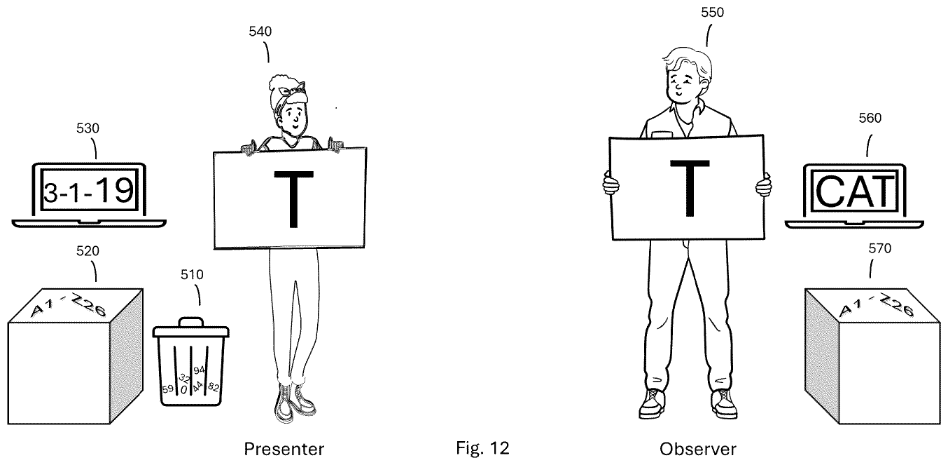

Referring to FIG. 12, if the intended receiver on a closed network asks the observer what the message said they have three ways to obtain a copy. If they want a digital copy in the same format it was sent to the presenter 540, the observer 550 looks on the back of each card and enters 3-1-19 into a digital data file. Even though in the same format, the analog characters may be output to the receiver as atomic digital characters in a data only context. This is the least secure option for the receiver. If the receiver wants a copy of the text in the message, the observer types the letters C A T into a word processor on their laptop, saves the document, and sends it to the receiver. It is important to note that the the letters the observer saw and captured displayed no numeric values, and thus are non-executable by a computational device. When the receiver requests the content of the message as text the observer ignores the cards in their box 570, and types the letters into a plain text document using a normal word processor (with no macros, no embedded objects, no scripting features used). The observer gives the receiver the text document which cannot be executed as malware by opening the document in a word processor because C A T is an atomic sequence of non-executable analog characters, and not instructions in a digital data stream. The distinction between non-executable analog characters and instructions corresponds to reading malware code in a programing text book compared to executing malware code by typing it into a code interpreter or compiler. The third option is for the receiver to ask the observer 550 for the physical cards 570. This is equivalent to preserving what the observer saw in an analog visual format. The cards are physical manifestations of analog character representations in a format which cannot be executed in a computational device. The third option may not seem practical, however rapid advancements are occurring in photonic computing. The ability to receive analog characters and process data in a photonic format may create a malware barrier that is immune to digital malware.

The hypothetical demonstrates the digital to analog to digital process, the breaking of the digital chain, in the present device. Referring to FIGS. 1 and 11, the presenter has 27 cards, A-Z to choose from with the corresponding numeric value of the letter on the back of each card. In preferred embodiments of the present invention, the predefined character set enables the similar process of limiting the characters extracted by the character filter 110 to the bytes used to encode content in the digital data stream 9. The predefined character set is typically a subset of a standard character set, in the case of the hypothetical the cards in box 520, A-Z, are a subset of the alphanumeric character set A-Z, a-z, 0-9. In the present invention if only capital letters are used to encode content in an digital data stream, then the predefined character set may be a subset of the ASCII alphanumeric character set including only digital characters capital A through Z, having standard ASCII decimal values 65 through 90. In both the hypothetical, where the letter A is represented by the non-standard 1, and the present invention, where the digital character A is represented by decimal value 65, each digital character is represented by the standard numeric value 65, so that it can be processed by a computational device, digital characters are represented by numeric values which allows them to be processed by computers. Comparison of the number of the back of each card to the incoming digital data stream extracts cards from the presenters box and deletes other bytes in a similar fashion to the character filter 110 extracting digital characters with corresponding binary values in the predefined character set and deleting all other data.

The observer 540 also performs a similar service to the context filter 120 by applying rules to determine if a series of cards represents content in context, and if not ‘deleting’ the cards by returning them to their box. In both the hypothetical and the present invention, the only characters that can be displayed by the presenter 540 and the display module 150 are the analog characters that were originally available in the box 520 or in the predefined character set stored in immutable memory 131, respectively. The letters in box 520 and in the predefined character set represent the only data that can be communicated from the open network to the closed network.

Referring to FIGS. 11 and 12, the cards, similar to the analog character representations in the present invention, are displayed and captured. It is important to recognize that in both the hypothetical and in the present invention only analog character representations cross the room or the analog air gap. In the hypothetical cards with analog characters on them are held up by the presenter to be captured on the other side of the room by the observer. In the present invention analog character representations are held up on a display 20 to be captured across the analog air gap 80 by image sensor 30. If the hypothetical when the observer 550 hands cards to the receiver in the closed network or types the message in a word processor and gives the document to the receive, the analog character message is transferred to the receiver in a non-executable data only context. In the present invention when character data is output in analog format or in digital format it is also transferred in a non-executable data only context. Digital devices that do not enforce immutable processing pipelines and do not convert characters to continuously variable visual glyphs, not digitally constructed pixel representations, do not provide the level of protection of the present invention.

In preferred embodiments (FIG. 1), selection of a predefined character set is determined by the character encoding used to represent the incoming digital data stream received from the open network. The same predefined character set used to encode the incoming digital data stream is used by the character filter 110 to recognize, extract, and validate permitted characters within the stream. By selecting the predefined character set based on the encoding of the incoming data, the character filter 110 operates deterministically on known symbolic representations without requiring interpretation of executable instructions, protocol state, or control semantics. The predefined character set may correspond to a standardized character encoding or to a custom or restricted subset thereof, provided that the same predefined character set is consistently applied across the disclosed components. For example, if content in the source digital data stream was text written in the English language and encoded using ASCII alphanumeric characters, the predefined character set may consist of the same ASCII alphanumeric characters or a subset (for example, but not limitation, if it is known that some the content was encoded with capital letters only), for the English language.

In preferred embodiments (FIG. 1), regardless of how the predefined character set is selected, the predefined character set is incorporated into the set of immutable instructions executed by each immutable processor that utilizes character representations. In particular, the predefined character set is incorporated into the first set of immutable instructions stored in first immutable memory 131 executed by the first immutable processor 121 in the character filter 110 for recognizing, extracting, and validating digital character values corresponding to analog characters in the predefined character set. A corresponding copy of the predefined character set may be incorporated into the second, third, and/or fourth sets of immutable instructions executed by the second, third, and fourth immutable processors (122, 123, and 124) in embodiments configured to require access to the set of predefined characters by one or more of said immutable processors. For example, but not limitation, a copy of the predefined character set may be incorporated in the third set of immutable instructions in the display module 150 for converting extracted digital character values into analog character representations. Where reconversion is requested a corresponding copy of the predefined character set may be incorporated into the fourth set of immutable instructions executed by the fourth immutable processor 124 in the image processing module 135 for reconversion of captured analog character representations into digital form. The predefined character set and each corresponding copy are fixed at manufacture or configuration time and are inseparable from the immutable instructions unique to the respective processor, such that no processor relies on externally supplied character definitions, runtime updates, or dynamically interpreted character mappings. Each immutable processor operates solely on its locally coupled predefined character set in immutable memory 131, 132, 133, 134, without negotiating, synchronizing, or exchanging character definitions with any other processor, such that character interpretation remains fixed, independent, and non-dynamic across the system.

A distinguishing feature of the present invention is that the context filter 120 executes scripted analysis instructions that define filtering, validation, and contextual analysis operations applied to arrays of sanitized character data produced by the character filter 110. ‘Context’ as evaluated by the context filter 120 may be derived from structural information intentionally embedded in the incoming digital data stream by the originating system or author of the data stream. The context is not inferred, learned, or dynamically interpreted by the receiving system, but is explicitly defined by the organization, ordering, and labeling of character sequences within the stream or by other predefined means. In preferred embodiments, the incoming digital data stream is structured as a delimited text stream comprising predefined delimiter characters that designate stream boundaries, records, and fields. A begin-stream delimiter and an end-stream delimiter define the extent of the stream, one or more record delimiters designate individual records within the stream, and one or more field delimiters designate individual data fields within each record. The first record of the stream may comprise field definitions that explicitly establish the semantic context for subsequent records, such that the meaning and expected content of each field is defined by the author of the data stream prior to transmission.

In preferred embodiments (FIG. 1), the context filter 120 operates by executing scripts incorporated into the second set of immutable instructions stored in second immutable memory 132 executed by the context filter immutable processor 122 in the context filter 120. The scripts define deterministic comparison operations applied to subsequent records in the digital data stream relative to the predefined context established by the field definitions in the first record. So for example, if the digital data stream is data from text written in standard English, then the context is words written in English following standard English grammar. And so words not in standard English, from a database, for example, consisting of a standard English dictionary, will be flagged or deleted. Comparison is performed by evaluating the presence, order, delimiter structure, character composition, and field cardinality of each record relative to the predefined context, without interpreting executable code, evaluating control flow, or inferring intent. For example, where a record delimiter is designated by a first delimiter character and a field delimiter is designated by a second delimiter character, the context filter 120 verifies that each record contains the expected number of fields, that each field conforms to permitted character sets and formatting constraints associated with the corresponding field definition, and that no additional fields, reordered fields, or unexpected delimiters are present. Records that conform to the established context are permitted to pass for further processing, while records and fields that deviate from the established context are deleted, thereby enforcing author-defined semantic constraints using deterministic, non-executable character-level comparison.

In one non-limiting example, an incoming digital data stream is structured as a delimited text stream in which delimiter characters define the boundaries of the stream, individual records, and individual fields within each record. A begin-stream delimiter (for example, the character ‘[’) designates the start of the digital data stream. A record delimiter (for example, the character ‘|’) separates successive records within the stream. A field delimiter (for example, the character ‘,’) separates individual fields within each record. The first record of the stream comprises field definitions that establish the semantic context for all subsequent records in the stream. One or more subsequent records comprise data values corresponding, in order and structure, to the field definitions established in the first record. An end-stream delimiter (for example, the character ‘]’) designates the end of the digital data stream.

By way of example only, a digital data stream consisting of certain personal information regarding clients, employees or customers, may include such information as date of birth (DOB) and social security numbers (SSN) and may be represented as:
[Begin|ssn, dob|123-45-6789, Jan. 2, 2025|345-67-8901, Jan. 24, 2026|End]
   In this example, the first record following the begin-stream delimiter (|ssn, dob|) defines two fields and establishes the context that each subsequent record is expected to contain exactly two fields in a predefined order. The context filter 120 compares each subsequent record against this predefined context by verifying the presence and placement of the record delimiters and field delimiters, the number of fields per record, and the character composition of each field relative to permitted character sets and formatting constraints. In the example, but not for limitation, in addition to validating format social security numbers may be validated against numeric validation rules and dates of birth may be validated against valid calendar dates over a fixed span of years. Records that do not conform to the established context are rejected and deleted, thereby preventing the transmission of structurally or semantically inconsistent data across the air gap.

The scripts enable flexible, application-specific interpretation of character data while preserving the non-executable nature of the underlying content. The scripts do not alter processor behavior, instruction sequencing, or control logic, but instead define declarative or rule-based analysis operations applied to character data that has already been sanitized by the character filter 110. The scripts may be user-selectable or user-provided prior to manufacture and are incorporated as a component of the second set of immutable instructions written to a ROM module, as the second immutable memory 132 coupled to the second immutable processor, the context filter immutable processor 122.

The scripts are constrained by the display module immutable processor 123 executing the third set of immutable instructions, such that the scripts are evaluated only within a predefined, limited execution model that does not permit arbitrary code execution, memory modification, or control-flow alteration. As a result, flexibility in data analysis is achieved without introducing a programmable attack surface. In some embodiments, the scripts define operations for analyzing arrays of characters or character values, including sequential scanning, grouping, aggregation, and comparison operations. For example, but not limitation, a script may specify that a contiguous sequence of characters be interpreted as a value and evaluated against one or more rules. The scripts may support deterministic pattern-matching operations analogous to regular expression matching, wherein character sequences are compared against predefined patterns to identify, extract, validate, or reject specific formats. Such pattern-matching operations are performed deterministically using immutable logic and do not permit execution of arbitrary instructions embedded in the character data.

In other embodiments, the scripts incorporated into the second set of immutable instructions executed by the context filter immutable processor 122 in the context filter 120 may define verification operations against reference data, such as immutable tables, lists, or mappings written to the ROM module during manufacture containing the second set of immutable instructions coupled to the context filter immutable processor 122 prior to manufacture. For example, a script may specify that a value extracted from an array of characters be compared against a table of permitted values, ranges, identifiers, or codes. If the value does not correspond to an entry in the table, the script may cause the associated character data to be omitted from output and deleted. Such table-based verification enables complex contextual analysis, including validation of identifiers, cross-checking of fields, enforcement of policy constraints, and detection of anomalous or unauthorized values, while maintaining deterministic and non-executable processing.

Execution of scripts by the context filter 120 is strictly constrained by immutable control logic. The scripts do not comprise executable machine instructions and do not permit branching, memory access, or instruction execution beyond the predefined analysis operations supported by the context filter 120. The scripts define what analysis is to be performed, but not how the underlying context filter immutable processor 122 executes instructions. Accordingly, even though the scripts provide substantial flexibility in analyzing and interpreting sanitized character data, they do not enable execution of malicious code, self-modifying behavior, or runtime reconfiguration of processor logic. This architectural separation allows user-defined or application-specific analysis to be performed safely on character data output from the character filter 110 without compromising the security guarantees provided by immutable processors. Importantly, the scripts operate solely on character data within the immutable processing path that has already been filtered to remove bytes outside the predefined character set and the extracted characters have been propagated as arrays of non-linkable atomic symbols rather than as strings of text, ensuring that pattern matching and related analysis cannot be leveraged to introduce executable semantics. Thus, the context filter 120 provides flexible, script-defined analysis of sanitized character arrays, including pattern matching and table-based validation, while ensuring that all script execution remains deterministic, constrained, and non-executable in nature. It should be appreciated that the contextual analysis operates on collections of characters for evaluation purposes, while the characters remain represented as isolated atomic symbols and are not reconstituted into machine-interpretable syntax. Acting together, the character filter 110 and the context filter 120 extract permitted content in context from the incoming digital data stream and irreversibly delete all other data in the data stream, including data that may encode executable or malicious behavior. After context filtering any data not extracted from the digital data stream 9 for input to the display module 150 has been permanently deleted by the character filter 110 or the context filter 120.

The next step is conversion of digital characters by the display module immutable processor 123 executing a third set of immutable instructions stored in third immutable memory 133. Each byte in the third memory buffer 143 is converted into the analog character in the predefined character set corresponding to the binary value of the byte for display 20 on the open network side 70 of an analog air gap as an analog character representation. Conversion from digital to analog breaks the digital processing chain. In the embodiments described herein, the analog air gap 80 operates as a digital to analog isolation boundary that prevents any digital data structures from crossing between the digital processors that generate and display the sanitized characters and the image processor in the image sensor device that receives the optical output. The immutable processors on the open network side of the analog air gap output only permitted digital characters that are rendered as analog visual representations on a display surface. The resulting analog output consists solely of atomic analog optical phenomena representing individual characters, the representation lacking machine-interpretable structure and therefore not comprising discrete byte values, opcodes, or metadata.

Immutable instructions and scripts may be organized into one or more sets. A set may be executed by multiple immutable processors 121, 122, 123, and 124 or by a single immutable processor and may contain both shared instructions and processor-specific instructions. As noted, each immutable processor is capable of executing a variety of instructions in multiple steps. Each immutable memory module is bound to one and only one corresponding immutable processor and is not accessible or otherwise shared among the immutable processors, instructions may be identical across one or more processors but are independently instantiated as corresponding copies in immutable memory bound to each immutable processor. In preferred embodiments (FIG. 1), immutable memory 131, 132, 133, and 134 may be in one or more removable ROM modules configured as cartridges in which sets of immutable instructions and scripts are stored. The contents of the ROM module are not writable after manufacture. Each removable set of immutable instruction is bound to one and only one corresponding immutable processor. The immutable processors 121, 122, 123, and 124, are electrically decoupled from each removable ROM module unless and until the module is inserted into a keyed connector that electrically couples the module to an instruction address/data interface. After insertion, the immutable processor fetches and executes instructions only from the coupled ROM module.

In embodiments in which immutable memory 131, 132, 133, and 134 is configured as removable ROM modules, each immutable processor 121, 122, 123, and 124, may include a processor unique cryptographic identifier that is permanently established at manufacture and cannot be altered. The cryptographic identifier may comprise, for example a private cryptographic key stored in non-modifiable memory integrated with or inseparable from the immutable processor. Each removable set of immutable instructions including scripts in first immutable memory 131, 132, 133, and 134 is cryptographically bound to a corresponding immutable processor 121, 122, 123, and 124. Immutable instructions that are stored on removable, are in encrypted form, such that the immutable instructions cannot be decrypted or executed unless the removable instruction media is coupled to an immutable processor 121, 122, 123, or 124, possessing a corresponding cryptographic key. The cryptographic verification and decryption logic itself is implemented as immutable logic executed by the immutable processor and is not subject to modification, replacement, or update after manufacture. As a result, neither the cryptographic key nor the verification behavior can be altered by software, firmware updates, or incoming digital data streams.

In some embodiments in which immutable memory 131, 132, 133, and 134 is configured as removable ROM modules, the removable module stores (i) an encrypted instruction image and (ii) a signed instruction manifest comprising a cryptographic hash of the instruction image and execution metadata. A public verification key is permanently stored in immutable memory 131, 132, 133, and 134 coupled to the immutable processor 121, 122, 123, and 124, and immutable verification logic executed by the immutable processor verifies the signed manifest prior to decrypting or executing the instruction image. The decryption key used to decrypt the instruction image is not stored on the removable module and is non-exportable from the immutable processor; in some embodiments the decryption key is derived from a physically unclonable function of the immutable processor. In further embodiments, the removable module stores a wrapped content key encrypted to a processor-unique key such that the content key can be recovered only by the corresponding immutable processor. Accordingly, substitution of unauthorized instructions is prevented because instruction execution is blocked absent successful signature verification and successful recovery of the wrapped content key. Any cryptographic coupling or decryption is performed only by predetermined deterministic algorithms configured to recognize an expected key value and does not include generalized decryption, key negotiation, or other adaptive cryptographic processing.

Another distinguishing feature of the present invention is that the character representations displayed by the display module immutable processor 123 exist solely as analog optical continuously variable visual glyphs produced by the display module immutable processor 123 for display on display device 20, without any digital background layer, metadata, pixel buffers, or composite digital structures. In digital imaging systems, a still image or video frame may be composed of multiple digital layers, such as an alphanumeric character metadata rendered on top of a digital pictorial background as in Crane. Both the foreground character layer and the background layer consist of digital data structures comprising discrete binary values. Because these digital data structures may include arbitrary byte sequences, the background layer may contain embedded executable or partially executable code, steganographic content, or other structured digital information. When such a composite frame is captured or transmitted by a digital camera or digital interface, the entire set of underlying digital data, including but not limited to any embedded malicious code, may be reproduced, stored, or forwarded as digital information.

By contrast, in preferred embodiments (FIG. 1) of the present invention the character filter immutable processor 121 and the context filter immutable processor 122 extract only the digital characters permitted by the character filter 110 and context filters 120 and render each character as an analog visual representation on a display surface 20. The displayed character exists solely as an optical representation of the analog characters produced by the display hardware. The analog character representation of each individual character is a continuously variable visual glyph which consists only of continuously varying electromagnetic emissions corresponding to the shape, brightness, and other analog characteristics of the character. Such optical depictions may be communicated using visible or non-visible portions of the electromagnetic spectrum to the extent capable of conveying visually recognizable characters whose identity is determined by visual form recognition. It should be appreciated that an analog character representation as defined herein is a letter form, a continuously variable visual glyph, a member of the visual form class of analog characters.

Digital and analog characters are fundamentally different. As defined herein the analog letter ‘A’ is a continuously variable visual glyph which may be red or green or any other color, stretched or shrunk, serif or sans serif, it is a continuous variable which in any form is still recognized as the analog letter ‘A’. On the other hand, a digital ‘A’ has one numeric binary or digital symbolic value, in most encoding systems ‘A’ is encoded as the binary number 1000001 (decimal 65). After the encoding standard is agreed upon, the digital ‘A’ has one and only one binary value, ‘A’ cannot be morphed into 1000000 or 1000010 (decimal 64 or 66). Because the analog character representation is a continuously variable visual glyph, it contains no digital pixel data and no composite digital layers, it cannot embed, encode, or convey executable instructions or malicious digital content when subsequently captured as an analog character representation across the analog air gap 80 by an image sensor 30. When the image sensor 30 positioned across the analog air gap captures the analog visual representation, the sensor receives only the analog optical emissions and does not receive underlying digital pixel data, background layers, or any original digital data structure from which executable or malicious code could be reconstructed. Accordingly, the analog character representation does not communicate text-based malware or other executable code across the analog air gap, because the analog character representations do not contain machine interpretable values.

The sanitization of a digital data stream and analog-only communication across an analog air gap substantially reduces the risk of communicating executable content from an open network into a closed network. However, such sanitization and communication alone does not fully eliminate the risk that the communicated content could be manipulated after output from the invention into the closed network 55 if the content is subsequently reintroduced into digital execution contexts. In particular, once character data enters the closed network 55, the data may be intentionally or unintentionally combined with existing software, interpreters, processors, or execution environments already present in the closed network. In such cases, even character only data that was non-executable at the output boundary (digital diode 51) may acquire executable semantics after crossing the output boundary through downstream parsing, decoding, compilation, templating, interpretation, or other transformations performed entirely within the closed network. Accordingly, the security boundary created by the analog air gap may be weakened if the transferred data is permitted to reenter general-purpose digital processing environments without additional constraints.

Preferred embodiments (FIG. 1) therefore provide, as a necessary security measure, terminal handling options on the closed-network side that preserve at the output boundary (digital diode 51) the non-executable character of the transferred content and prevent the transferred content from being recombined with executable logic. These terminal handling options are not mere post-processing conveniences but are integral to maintaining the non-executable nature of the communicated content after egress 49 from the invention at the output boundary 51. The output boundary marks the extent of the claimed invention, and any system, subsystem, or component beyond the output boundary is external to the invention and is not claimed. The output boundary is characterized by the form, domain, and constraints of the output 49 produced by the invention, including where applicable but not limited to, sanitized character data, non-executable content, analog character representations, or other constrained representations resulting from the disclosed processing. The output boundary is independent of the structure, configuration, or operation of any external system that may receive the output.

In accordance with the additional embodiments, analog character representations communicated across the analog air gap are processed on the closed network side 90 of the analog air gap by a fourth immutable processor, also called the image processing immutable processor 124 executing a fourth set of immutable instructions stored in fourth immutable memory 134 coupled to the fourth immutable processor 124 executing a controlled and deterministic architecture that prevents executable code, executable instructions, or machine-instruction semantics from being introduced into the closed network 55. After optical capture of analog character representations and storage in a memory buffer 144, processing proceeds along one of two mutually exclusive paths, depending on whether a digital representation is required or desired, or whether the analog character representation is to be preserved. Each path is specifically structured by the fourth set of immutable instructions stored in fourth immutable memory 134 to prevent the reformulation, reconstruction, or synthesis of executable content.

In a first processing path where reconversion to digital is desired, captured analog character representations are converted by the immutable image processor 124 executing the fourth set of immutable instructions in fourth immutable memory 134 coupled to the fourth immutable processor 124 into binary values corresponding to individual characters in a predefined character set stored in the fourth immutable memory 134. The predefined character set stored in the fourth immutable memory 134 is a copy of the predefined character set stored in the first immutable memory 131, such that the conversion from digital characters to their corresponding analog characters and analog character representations in the third immutable processor 123 in the display module 150 is reversed in the fourth immutable processor 124 in the image processing module 135 with each analog character representation being reconverted to their corresponding digital character. This conversion is performed by the fourth immutable processor 124 in the image processing module 135 executing the fourth set of immutable instructions including a copy of the predefined characters set stored in immutable memory 134 performing deterministic character-recognition operations that identify individual characters based on visual or photonic features; mapping each identified character to a corresponding discrete binary value defined by the predefined character set; and generating only individual character binary values without generating instruction sequences, control structures, or executable formats.

The resulting binary values are output 49 as sanitized digital character data, which is expressly limited to non-executable textual data. The external output subsystem in the closed network 55 receiving such data is configured to process and store the data solely as inert character content, without parsing, interpreting, or executing the data as instructions or machine code. Because conversion is limited to a predefined character set and produces only atomic, discrete character values, executable constructs, such as opcodes, scripts, macros, binaries, or instruction streams, cannot be formed or reconstructed unless the data is intentionally processed in the external subsystem as executable binary code.

In a second processing path captured analog character representations are retained in analog form and are not converted into binary values. In this path the fourth immutable processor 124 in the image processing module 135 executing a fourth set of immutable instructions 134 retains the analog character representation in the fourth memory buffer 144 and no digital encoding, parsing, or interpretation of the representation is performed, for example, but not limitation as a pixel based raster image by storing said raster image in a data structure devoid of standard character encoding information, thereby necessitating the use of image processing or other similar techniques for subsequent display or manipulation. The analog photonic character data is communicated 49 by the fourth immutable processor 124 in the image processing module 135 to a photonic processor subsystem external to the system configured to process the optical characteristics of the photonic signal without converting the signal into binary digital data. The downstream subsystem in the closed network 55 is configured to receive and process the representation in the analog domain, for example, but not limitation, for visual display, analog storage, or photonic-domain processing. Importantly, the analog character representation does not possess a discrete numeric encoding, instruction structure, or executable semantics. As a result, it cannot be reformatted, reinterpreted, or executed as machine instructions.

Specifically, photonic processors and related analog-domain processing techniques are an emerging area of technology, and specific implementations may vary as the technology develops. The present disclosure is not limited to any particular photonic architecture, fabrication method, or degree of commercial maturity, and encompasses future photonic or optical-domain processors capable of operating on analog character representations without binary conversion. Photonic processors may be configured to input, process, and output data in analog form. Photonic processors are, for example, but not limitation, designed to accelerate processing of large language models in artificial intelligence servers in data centers. In certain embodiments it is advantageous to increase performance and security by implementing photonic processors configured to input, process, and output analog characters as optical representations uniquely identified by one or more analog attributes, allowing the processing of analog characters as photons without conversion to digital characters.

A photonic processor subsystem may perform analog transformations on optical character data output by the present invention using integrated photonic circuits, such as optical filters, interferometers, modulators, and waveguide-based correlation structures. These analog photonic operations identify a character based on its analog optical profile while avoiding any quantization or representation of the data as a discrete binary value. Because the photonic processor does not generate or manipulate binary values, opcodes, or digitally encoded character data, no binary executable malicious code may be introduced or executed within the photonic processor. The processing of analog photonic character data is thus inherently immune to digital code injection attacks, as the processor lacks any digital instruction pathway or binary data representation capable of executing such code. It is believed that embodiments implementing photonic processors provide a degree of security for data that exceeds the level of security achievable by existing digital methods.

It should be further appreciated that at the closed-network side 90, the captured optical depictions are processed by the fourth immutable processor 124 in the image processing module 135 that applies predetermined image-domain transformations independent of image content. Because the processor executes fixed operations and does not interpret image data as instructions, the captured depictions cannot introduce commands, code, or protocol structures into the output. The data produced at the output boundary (digital diode 51) therefore represents only the recognized analog characters, whether delivered as digital data or retained in analog form, and is isolated from malicious executable content present in the source digital data stream.

Any system, subsystem, or component that receives output from the disclosed invention in the closed network 55 but is not expressly recited in the claims is external to the invention and is not claimed. The present invention terminates at the output boundary (digital diode 51) between the disclosed apparatus or method and any closed-network or downstream system that receives the output thereof. Such external components are described, if at all, solely for contextual or illustrative purposes, and no claim of patentability is made with respect thereto, the configuration and use of such external components are intentionally left to the discretion of the user of the invention. The disclosed invention nevertheless includes the generation and provision of an output boundary 51, the output being produced in a constrained form that is a direct result of the disclosed filtering, processing, and communication operations. Such output may be delivered to an external system solely for use or further processing, and no claim of patentability is made with respect to the external system itself. However, the manner, form, and constraints under which the output is generated and made available are integral aspects of the invention and are independent of any subsequent handling by downstream systems. For clarity, the disclosed invention produces its output at the output boundary in the claimed form, and any subsequent processing, storage, interpretation, or use of that output occurs outside the scope of the invention.

Across the processing paths, preferred embodiments of the present invention enforce multiple independent barriers that prevent the reintroduction of executable content, including but not limited to:
(a) absence of binary instruction encoding—analog character representations comprised of atomic analog optical phenomenon lack discrete binary values and therefore cannot encode executable instructions.
(b) predefined character set limitation—when conversion occurs, only individual characters from a predefined character set are produced, preventing formation of executable instruction sequences.
(c) deterministic processing—character recognition, context analysis, and conversion operations are deterministic and immutable, preventing adaptive or interpretive behavior that could synthesize executable content.
(d) separation of storage and communication—analog character representations are retained in memory buffers and are communicated only once, downstream, without intermediate transformation.
(e) non-executable downstream configuration—external subsystems receiving either digital character data or analog character representations may be configured to process the data without executable interpretation.

By structuring processing such that character representations of content are either converted into isolated, non-executable digital characters, or preserved and communicated solely in non-executable analog form, executable code is prevented from traversing an analog air gap. This dual-path architecture provides flexibility in data handling while maintaining strict separation between character content and executable behavior. When considered as a whole, preferred embodiments of the present invention operate in a manner fundamentally distinct from prior art approaches to data filtering and secure transfer of information.

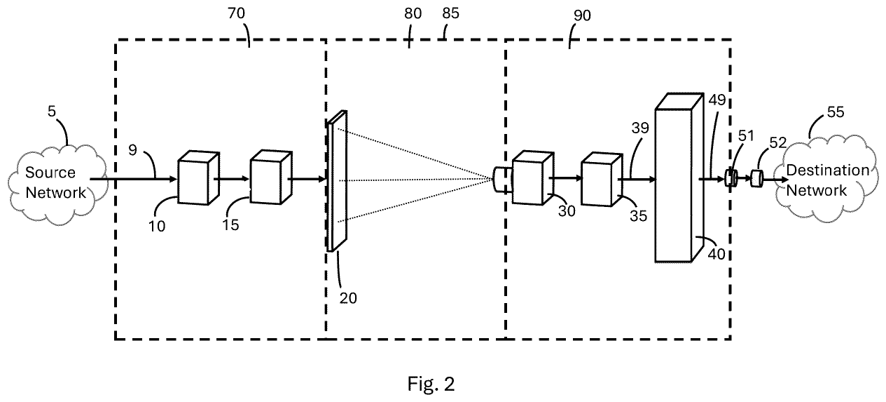

Referring now to FIG. 2, another embodiment of the present invention includes an apparatus and method which receives a digital data stream from an open network source 5 into a data preparation area 70; identifies and extracts digital content 9 embedded in the digital data stream utilizing the digital processor in digital filter device 10; blocks malicious digital code by deletion of the remaining digital data stream; converts the extracted digital content utilizing the digital processor in display driver device 15 into a pictorial image consisting of alphanumeric and/or other defined pictorial characters which is displayed on a display device 20 on one side of an analog air gap 80 enclosed in a protective sheath 85; captures the pictorial image on an image sensor device 30 located in a protected data facility 90; utilizes the digital processor in the image sensor device 30 to convert the pictorial character image into a digital image file in a closed network; utilizes optical character algorithms executed by the digital processor in the digital conversion device 35 to convert the captured pictorial image file into a clean content file 39; stores a read only archival reference copy of the clean content file 39 in a closed network storage device 40 in the protected data facility; and on request delivers copies of the archival reference copy across a one way digital air gap utilizing digital diodes 51 and 52 to a destination network 55. Whether specifically stated or not, the dedicated digital processor devices and other devices as described herein should be understood as being capable of, and programmed to, execute the methods and functions of the present invention, such as execution of optical character recognition algorithms.

Referring to FIG. 2, in one preferred embodiment of the present invention digital data received from individuals, entities, customers, institutions, governmental units, and other sources is input as a digital data stream from open network 5. The source digital data stream is processed in a data preparation area 70 by parsing the digital data stream utilizing a digital processor in a dedicated digital filter device 10 programmed to recognize and identify digital content 9 embedded in the digital data stream which is capable of representation as pictorial characters. The digital content is extracted from the digital data stream and the remaining digital data stream is deleted by the digital filter device 10.

The digital content is converted into a pictorial character image consisting of alphanumeric characters and/or defined characters utilizing a dedicated digital processor in display driver device 15 programmed to execute digital conversion and display device driver algorithms. The pictorial character image is displayed on a display device 20, for example a computer monitor.

The display device 20 is attached to the external wall of the data preparation area 70 facing an image sensor device 30. The pictorial image of characters displayed on the sending display device 20 is communicated in a one way direction across the analog air gap 80 and captured on the image sensor device 30 which is located on the opposite side of the analog air gap. The dedicated image sensor device 30 consists of one or more optical lenses, one or more image sensors, and one or more dedicated digital processors (similar to a lens, image sensor, and digital processor in a digital photographic camera) configured and programmed to capture and convert the pictorial image on display device 20 into a digital image file 33, for example a portable network graphics (.png) file, for further processing in the digital conversion device 35. The dedicated digital processor in the image sensor device 30 may also be programmed to remove unintended and unwanted digital artifacts from the pictorial image, for example aliasing resulting from the capture of the displayed pictorial image.

The analog air gap 80 is enclosed in a protective barrier or sheath 85, designed to meet the same or higher security standards as the secure digital data facility 90 to prevent interception of information crossing the analog air gap or injection of malicious code between the display device 20 and image sensor device 30. The protective barrier 85 surrounding the analog air gap 80 is affixed to the outer wall of the data preparation area 70 and the outer wall of the secure protected data facility 90, and acts as a sheath enclosing the analog air gap 80 to isolate and protect both the display device 20, the one way communication path, and the image sensor device 30 from cyberthreats.

The dedicated image sensor device 30 is located within a secure protected data facility 90 which isolates and protects both the image sensor device and other devices inside the protected data facility 90 from cyberthreats. The image sensor device 30 captures the image through a protected opening in the outer wall of the secure data facility 90 which maintains the integrity and security of the secure data facility. The secure data facility may be designed to meet various levels of security standards up to or exceeding the security requirements of the United States Department of Defense for certification as a Sensitive Compartmented Information Facility (as prescribed in Intelligence Community Directive 705, 705-1, 705-2, and successor regulations).

The pictorial character images encoded in the digital image file 33 are processed by the dedicated digital processor in the digital conversion device 35 which is programmed to execute optical character recognition algorithms to convert the pictorial character images in the digital image file 33 into digital data in the clean content file 39.

The digital content contained in the clean content files 39 is an accurate unformatted copy of the information extracted from the digital content 9 in the source data 5 and is archived as a permanent reference copy in the closed network storage device 40 located within the secure protected digital data facility 90. The archival reference copy is recorded on encrypted write once read many (WORM) times magnetic tapes, optical discs, holographic media, and/or other storage media restricted to the one time recording and multiple reading of the digital data. At the request of an authorized individual or entity or entity a copy of the archival reference copy may be generated and transmitted across the digital air gap 50 to the requesting party through the destination network 55, however the reference copy is never altered or removed from the protected data facility 90.

In some embodiments of the present invention, to reduce aliasing frame rates may be chosen that are approximately the same for both display device 20 and image capture sensor device 30 and/or a sufficient delay between communication of images may be employed so that multiple display refresh and image sensor capture cycles may be recorded for each displayed pictorial image, with the digital processor within the image sensor device 30 and/or the digital conversion device 35 selecting the image containing the least number of unwanted digital artifacts and/or combining images to generate a composite image having the least number of unwanted digital artifacts. To increase throughput, continuous display and capture of multiple frames containing pictorial images (similar to stop motion photography) may be employed with the frames having the least number of unwanted digital artifacts selected by the image sensor device 30 and/or the digital conversion device 35 for further processing.

The digital conversion device 35 may add index and other digital code to the digital character strings which is useful in the storage, maintenance, and retrieval of the digital content, for example unique index values may be added identifying the open network source of the digital content. The flow of all digital data received from open source networks 5, processed by the present invention, and sent to designation networks 55 outside the secure data facility is one way, unidirectional. In some embodiments of the present invention, a request for a copy of a clean content file 39 stored within the closed network storage device 40 is transmitted into the secure data facility 90 utilizing the same and/or similar one way apparatus and methods used to transmit pictorial character digital content into the secure protected data facility 90. The alphanumeric index value of the requested archived reference copy may be displayed on the display device 20, captured by the digital image sensor 30, and programmatically recognized by the digital conversion device 35 utilizing optical character recognition algorithms as a request to retrieve a copy of clean digital content with the matching alphanumeric index. A copy of the archival reference copy 49 of the clean content file 39 is retrieved from the closed network storage device 40 and sent across a unidirectional digital air gap 50 utilizing one way digital diodes 51 and 52 and/or similar devices to the authorized requesting party in the destination network 55. The methods and devices utilized to process a request for a copy of the stored clean content file enforce one way transmission of clean content and do not allow the transmission of digital data into the secure data facility 90.

Digital data diodes 51 and 52 and/or similar devices enforce one way data flow and are used as the only method of transmission of information from inside the secure protected data facility 90 across an out bound digital air gap to the destination network 55 outside the facility. To maintain unidirectional data flow, transmission of data is accomplished utilizing devices and methods which do not require bidirectional exchange of timing or other digital information. For example, but without limitation, digital diodes 51 and 52 (and as described in other embodiments digital diodes 53 and 54) are designed to transmit unidirectional data flow by operating in a standby mode, with the receiving diode 52 waking on detection of output from the sending diode 51. Timing may be synchronized by the digital diode receiving unit 52 monitoring a one way signal (such as activation of a red light) from the digital diode sending unit 51 which is not capable of transmitting digital data. There is no transmission of data or other digital signals from a digital diode and/or other device outside the secure data facility 90 (and as described in other embodiments the secure data area 91) to a digital diode and/or other device inside the secure protected data facility 90.

In some embodiments of the present invention, the digital processors and sensors utilized in devices 10, 15, 30, and 35 may be physically and/or programmatically restricted to the recognition and processing of pictorial character sets selected for communication of digital content, and rendered incapable of any other recognition and processing. For example, but without limitation, the digital content may be processed by the display driver device 15 capable of displaying the selected pictorial character set on a monitor or other similar display device 20 and rendered physically or programmatically incapable of displaying other information. This may be accomplished by the digital processor in the display driver device 15 being programmed to activate only those pixels necessary to display the selected pictorial character set and to reject the activation of any other display pixels, and/or the display pixels may be physically disabled in the display device 20 circuitry and/or the physical components of the display device. For further example, specific pixels in an LED/LCD monitor may be physically rendered incapable of activation and display.

In some embodiments of the present invention, optical character recognition algorithms utilized in the digital conversion device 35 may include artificial intelligence and machine learning methods to improve the accuracy of the capture; recognize and correct data bytes having values outside the range of the selected set of characters; warn of the possible use of steganography to obfuscate malicious code in strings of alphanumeric characters; and/or perform other functions useful for the creation, storage, and retrieval of clean digital content. To facilitate recognition of pictorial character images, the digital processor in the display driver device 15 may be programmed to display the digital content utilizing a font and format that is optimized for recognition by the optical character recognition algorithms executed by the digital conversion device 35.

In some embodiments of the present invention, additional methods may be applied in the digital processors in digital devices 10 and 35 which recognize executable code transformed into human readable pseudo content by cybercriminals using steganographic techniques to obfuscate malicious code. For example, but without limitation, the digital processors in devices 10 and 35 may utilize artificial intelligence to recognize pseudo content and embedded malicious code which use the least significant bits of ASCII values of otherwise valid characters to inject malicious code. Another example, artificial intelligence may be used to train filters to recognize and block, or warn operators of, non-sensical or otherwise grammatically incorrect words or sentences and numerical values outside an expected range.

In some embodiments of the present invention, data processing algorithms may be executed in virtual machine processing environments within the digital processors utilized in devices 10, 15, 30, 35, and other digital processors which process digital content. The virtual machines isolate the digital content, algorithms, and data on which they operate from other digital processors and data in the closed network. For example, but without limitation, all processing of pictorial images within the protected data facility 90 may occur in virtual machines utilizing hardware implemented virtualization technology and operating systems which effectively isolate virtual machines containing digital content from any and all other virtual machines containing digital data within the closed network.

In some embodiments of the present invention, the pictorial image of alphanumeric characters and/or other defined characters is communicated from the sender to the receiver across an analog air gap 80 by electromagnetic waves with frequencies outside the human visible spectrum, by light transmitted through fiber optic bundles, and/or by other mediums capable of communicating analog information. In some embodiments of the present invention, multiple parallel input, processing, storage, and/or output devices may be employed to increase the throughput into and out of the protected data facility 90.

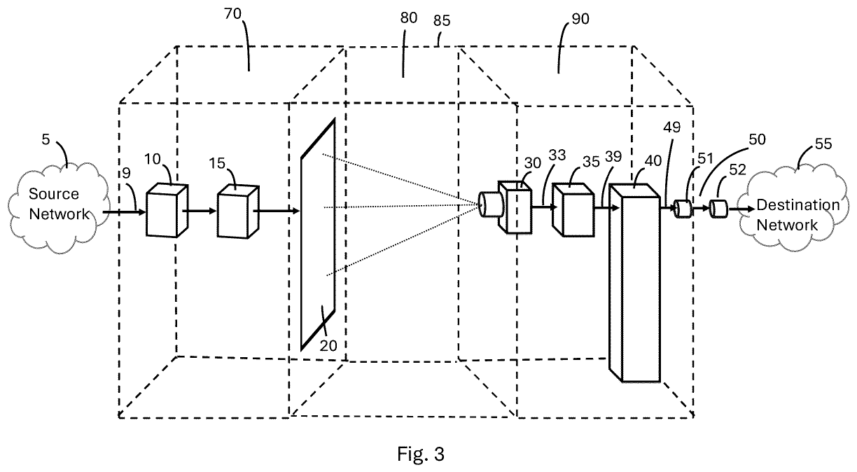

Referring to FIG. 3, in some embodiments of the present invention, a second dedicated image sensor device 31 which consists of an optical lens, one or more image sensors, and dedicated digital processors, may be utilized to capture a pictorial image of the digital content 9 in the source digital data stream including both digital content which is capable of representation as pictorial characters and pictorial information which is not capable of representation as pictorial characters. The extracted digital content 9 from source network 5 may be displayed on a monitor or other display device 20, captured as a pictorial image by the image sensor device 31, converted by the digital processor in image sensor device 31 to a pictorial digital image file 33, and stored in a second closed network storage device 41 within the protected secure data area 91. In the embodiments illustrated in FIG. 3 the second image sensor device 31 is optically focused and/or physically configured and/or programmed to capture and record the digital content displayed on the display device 20 as a pictorial image. Recording of the pictorial image is useful for preservation of digital content containing pictorial information which is not suitable for extraction and conversion into pictorial characters, for example illustrations and photographs contained in the source digital data stream. It should be appreciated that in the various embodiments of the present invention illustrated in FIGS. 3, 4, 5, and 6 the image sensor device 31 is optically focused and/or physically configured and/or electronically programmed utilizing digital image recognition and cropping algorithms, to capture selected components of the digital content and other pictorial images displayed such as pictorial character images, pictorial information, format markup language, and/or similar pictorial representations of data, similar to the manipulation of an optical camera lens to selectively photograph one or multiple views of various components of an object. In the embodiments illustrated in FIG. 3 the second image sensor device 31 captures and records the digital content which is displayed on display device 20.

In such embodiments the capture, conversion, and storage of the digital pictorial image file 34 occurs in a closed network within a designated secure data area 91 inside the protected data facility 90, which is separate and isolated from other areas within the protected data facility 90 and which meets or exceeds the isolation standards applied to the protected data facility 90. There is no physical, electronic, or other communication between the secure data area 91 and other areas within the protected data facility 90. Digital data diodes 53 and 54 and/or similar devices enforcing one way data flow are used as a method of transmission from the designated secure data area 91 to a destination network 55 outside the secure data facility.

For example, but without limitation, a document containing text, illustrations, photographs, and inked signatures may be displayed on a monitor or other display device 20, captured by an image sensor and converted to a digital image file 34 in the dedicated image sensor device 31, and stored in the second closed network storage device 41 within the secure data facility secure data area 91. Because the displayed image is a pictorial image which is captured by the image sensor and converted into the new digital image file 34 it is unlikely to be capable of containing malware. Furthermore, in some embodiments, the dedicated digital processor device in the image sensor device 31 may be programmed to perform bit operations on the digital image file 34 which preserve pictorial digital content while deconstructing any obfuscated malicious code in the image, such as an embedded QR code.

If requested by an authorized individual or entity, the clean content file 39 and digital image file 34 may be utilized to reconstruct the digital content, by applying a digital method and/or device (not shown) inside or outside the protected data facility 90 and the designated digital secure data area 91, in a format and layout closely approximating the format and layout in the source digital data stream, for example a reconstructed copy having the same illustrations, inked signatures, particular font, font size, and margins as in the source digital data stream. A warning accompanies any copy of the digital image file retrieved by an authorized individual or entity stating that the image may contain malicious code in the form of pixel patterns, and that the archival reference copy retrieved from the closed network storage device 40 should be considered to be the only version known to contain only clean digital content. The reconstructed copy may be delivered utilizing print or other similar analog pictorial medium to eliminate any digital cyberthreat vectors.

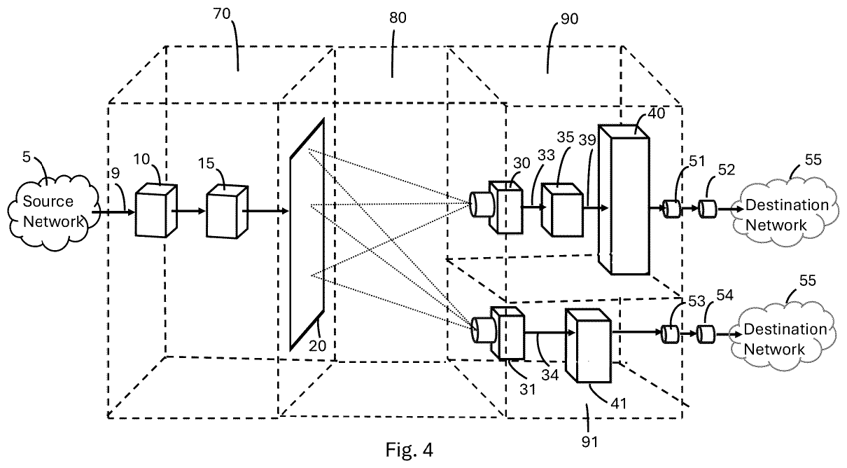

Referring to FIG. 4, in some embodiments of the present invention, the pictorial image of the digital content as originally formatted may be captured and parsed outside the protected data facility 90 in the data preparation area 70 to determine the layout of original content, which may then be recorded in a meta data format utilizing markup language (for example XML, or Rich Text Format). The meta data is constructed from an image of the original document displayed on the display device 11; captured by the image sensor device 12, which consists of an optical lens, one or more image sensors, and dedicated digital processors; and converted into a pictorial character image of the meta data by the digital processor in the display device driver 16, and is not obtained from meta data embedded in the source digital data stream from the source network 5. The pictorial image of the meta data may be displayed along with the pictorial characters generated by display driver device 15 on the display device 20 and/or displayed on a similar display device; captured by the image sensor device 31 which consists of an optical lens, one or more image sensors and dedicated digital processors; processed by the digital conversion device 35; stored in the closed network storage device 40 with the digital content consisting of pictorial characters, and, if requested by an authorized individual or entity, used to format the clean content in a format and layout closely approximating the format and layout in the source digital data stream, for example having a particular font, font size, and margins. In the embodiments illustrated in FIG. 4 the second image sensor device 31 captures and records the meta data which is displayed on the display device 20.

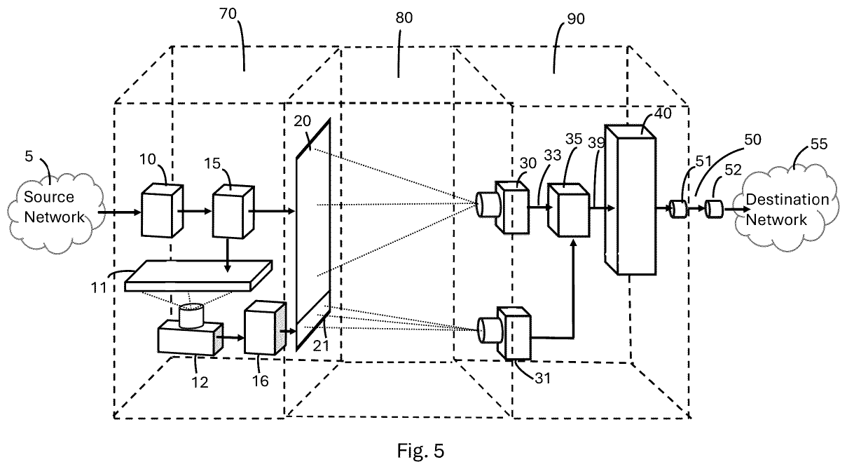

Referring to FIG. 5, in some embodiments of the present invention, the second dedicated image sensor device 31 which consists of an optical lens, one or more image sensors, and dedicated digital processors, may be utilized to capture a pictorial image of the digital content 9 in the source digital data stream including both digital content which is capable of representation as pictorial characters and pictorial information which is not capable of representation as pictorial characters. The extracted digital content 9 from source network 5 may be displayed on a the display device 20, captured as a pictorial image by the image sensor device 31, converted by the digital processor in the image sensor device 31 to the pictorial digital image file 33, and stored in the second closed network storage device 41 within the protected secure data area 91.

Furthermore, the pictorial image of the digital content as originally formatted may be captured and parsed outside the protected data facility 90 in the data preparation area 70 to determine the layout of original content, which may then be recorded in a meta data format utilizing markup language (for example XML, or Rich Text Format). The meta data is constructed from an image of the original document displayed on the display device 11; captured by the image sensor device 12, which consists of an optical lens, one or more image sensors, and dedicated digital processors; and converted into a pictorial character image of the meta data by the digital processor in the display device driver 16, and is not obtained from meta data embedded in the source digital data stream from the source network 5. In the embodiments illustrated in FIG. 5 the second image sensor device 31 captures and records the digital content and the meta data which is displayed on the display device 20.

If requested by an authorized party, the digital content file, the meta data, and the digital image file may be utilized to reconstruct the digital content, utilizing a digital process or device (not shown) inside or outside the protected data facility 90 and the designated secure data area 91, in a format and layout closely approximating the format and layout in the source digital data stream, for example having illustrations, inked signatures, particular font, font size, and margins. A warning accompanies any copy of the digital image file retrieved by an authorized individual or entity stating that the image may contain malicious code in the form of pixel patterns, and that the archival reference copy retrieved from the closed network storage device 40 should be considered to be the only version known to contain only clean digital content. The reconstructed copy may be delivered in print or other similar analog pictorial medium to eliminate any cyberthreat vectors.

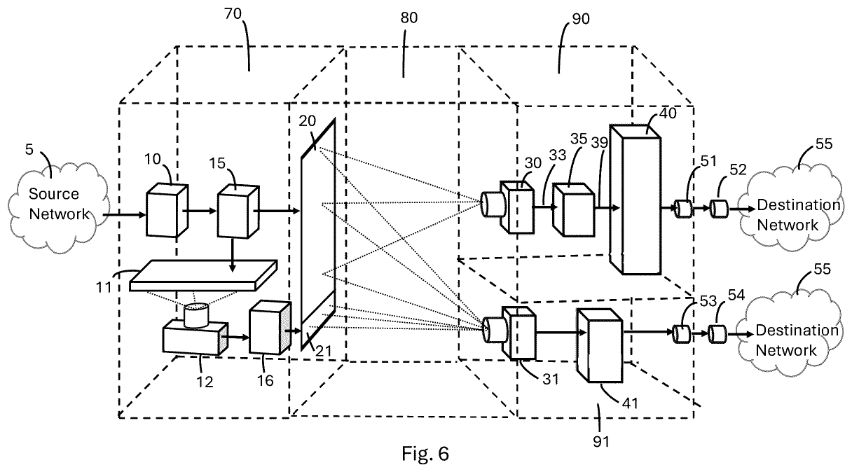

Referring to FIG. 6, in some embodiments of the present invention the digital content file, the meta data, and the digital image file may be utilized to reconstruct the digital data as illustrated in FIG. 5 inside the designated secure data area 91 by transmitting a clean digital content file from closed network storage device 40 in the protected data facility 90 across a digital air gap to the digital conversion device 35 in the designated digital image area 91 utilizing one way digital diodes 37 and 38. On request by an authorized individual or entity a copy of the archived clean content may be transmitted to a destination network 55 utilizing digital diodes 51 and 52 and/or a reconstructed copy in a format and layout closely approximating the format and layout in the source digital data stream may be transmitted to a destination network 55 utilizing digital diodes 53 and 54. A warning accompanies any copy of the digital image file retrieved by an authorized individual or entity stating that the image may contain malicious code in the form of pixel patterns, and that the archival reference copy retrieved from the closed network storage device 40 should be considered to be the only version known to contain only clean digital content. The reconstructed copy may be delivered in print or analog pictorial medium to eliminate any cyberthreat vectors. In the embodiments illustrated in FIG. 6 the second image sensor device 31 captures and records the digital content and the meta data which is displayed on the display device 20.

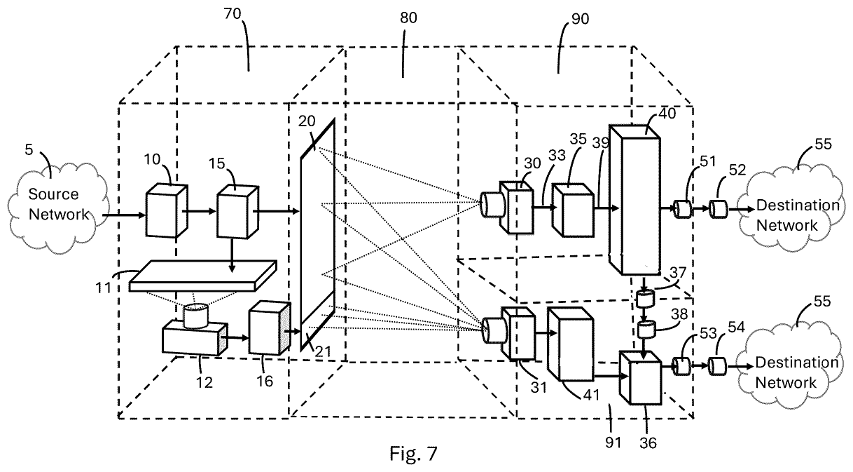

Referring to FIG. 7, in some embodiments of the present invention, the various components of the apparatus are separated into modules which may be combined in various configurations for the purpose of increasing or decreasing processing and storage capacity and speed and/or for other purposes. Each module may be removed for repair and maintenance and/or a replacement module may be installed. For example, but without limitation, a data preparation module 100 housing the digital filter device 10; a data preparation module 101 housing the display driver device 15; an air gap module 102 housing the display device 20, the analog air gap 80, and the external portal to image sensor device 30; a secure data facility processing module 103 housing the digital conversion device 35; and a secure data facility data storage module 104 housing the closed network storage device 40 and one way digital diode 51 to transmit data out of the module to digital diode 52 and destination network 55. It should be understood that all embodiments of the present invention may be separated into modules which may be combined in various configurations. It should be appreciated that one or more embodiments of the present invention may be combined and/or implemented in one or more modules such that a module and/or modules may perform more than one process, for example, but without limitation, modules 103 and 104 may contain any combination of devices 30, 31, 35, 36, 40, 41, 51, and 53 so as to be programmatically configurable to execute the embodiments illustrated in FIGS. 2, 3, 4, 5, and/or 6.

In some embodiments of the present invention, the modules may be portable and self-contained. In such embodiments a self-contained environmental module 105 is attached, usually as a base, which provides electrical isolation, cooling, physical and electronic security, and other functions required by the chosen level of security. In such configurations the entire apparatus may be designed to meet or exceed the requirements of the United States Department of Defense for certification as a Sensitive Compartmented Information Facility (as prescribed in Intelligence Community Directive 705, 705-1, 705-2, and successor regulations) regardless of the security level of the facility in which the modules are located and operated.

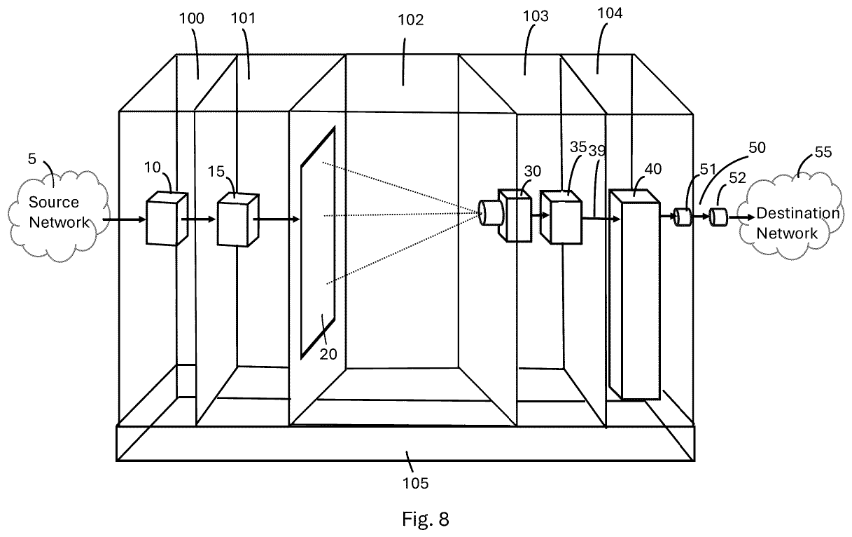

Referring to FIG. 8, in some embodiments of the present invention, the apparatus and methods of the present invention are configured as a digital filter for use in existing private closed networks to process clean content which is transmitted in real time across digital air gap 50 to a destination network 55 for real time of delayed use. An archival reference copy of the clean content may also be stored in the closed network storage device 40.

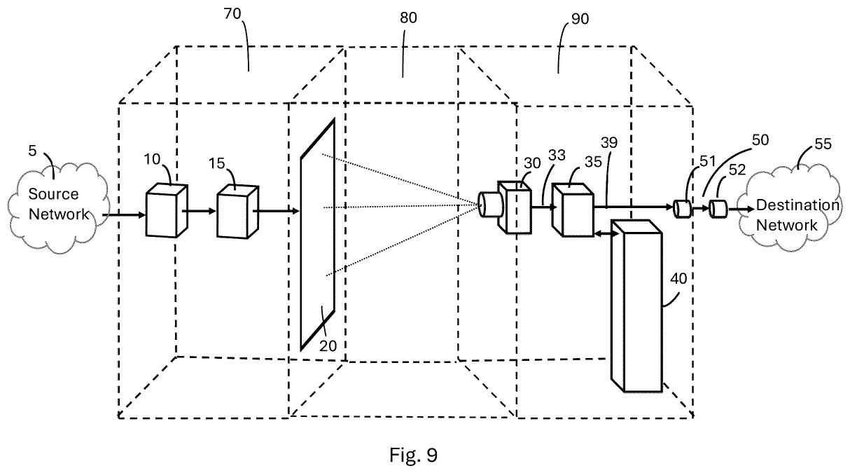

Referring to FIG. 9, in some embodiments of the present invention, a digital processing and storage device configured as a database server 45 may be present inside the protected data facility 90 and may contain copies of clean content data extracted from digital archival reference copies stored in the closed network storage device 40. For example, but without limitation, an archival copy of clean content containing personal identifiable information (PII) of individuals may be utilized to create database records containing the dates of birth of individuals. One or more authorized entities or individuals providing the PII may subscribe to the database as software as a service (SaaS) and input PII and other similar data in the source digital data stream for inclusion in the database 45.

An authorized individual or entity may make a unidirectional request for access to PII and/or other data stored in the database server 45 utilizing the same and/or similar one way apparatus and methods used to transmit clean content into the protected data facility 90. In some embodiments of the present invention, the request may be made using an application programing interface (API) which transmits the request utilizing the same and/or similar one way apparatus and methods used to transmit clean content into the secure data facility 90. The database device 45 validates and services authorized requests by real time transactional or delayed transmission across the digital diode air gap 50 to authorized entities or individuals who provided the data or are otherwise authorized to possess the requested digital content. As part of authorization to access data stored in database server 45, individuals and entities are required to provide evidence of compliance with privacy laws, regulations, policies, and best practices.

In some embodiments of the present invention, the database server and database software 45 may contain copies of PII and other data related to one individual which was submitted by more than one individual or entity. In such cases a many to one index is maintained in the database server by the database software associating more than one authorized individual or entity with a single individual's PII. The database is normalized so that there is no duplication of PII or other data. Authorized requests for copies of PII and other data from more than one authorized individual or entity are served from the single, normalized, PII data record for the individual.

Algorithms in the digital processor in the database server 45 monitor requests for retrieval of PII and other protected data and generate operator warnings and/or deny requests if the volume is abnormally high; other anomalous patterns of request are detected; and/or if a request for PII is received from an unauthorized individual or entity. The apparatus and methods of the present invention protect PII, including data subject to HIPAA (Health Insurance Portability and Accountability Act) and GDPR (General Data Protection Regulation) regulations, and significantly reduce the risk of data breaches.

The foregoing descriptions of possible implementations consistent with the present disclosure do not represent a comprehensive list of all such implementations or all variations of the implementations described. The description of some implementations should not be construed as an intent to exclude other implementations described. For example, artisans will understand the present specification as describing how to implement the disclosed embodiments in many other ways, using equivalents and alternatives that do not depart from the scope of the disclosure. Moreover, unless indicated to the contrary in the preceding description, no particular component described in the implementations is essential to the invention. It is thus intended that the embodiments disclosed in the specification be considered illustrative, with a true scope and spirit of invention as described herein.

Certain embodiments and implementations are presented as illustrative examples of the invention. These embodiments include configurations and operational features that may be implemented independently, in combination, or as alternatives to other disclosed embodiments, depending on design objectives and application requirements. Some embodiments described herein refine, extend, or reorganize functional elements previously disclosed, while other embodiments may incorporate additional structures or processing steps that were not expressly required in earlier implementations. Unless expressly stated otherwise, no embodiment is intended to be limiting, and the invention is not confined to any particular ordering, grouping, or hierarchy of features. Rather, the scope of the invention encompasses all disclosed embodiments and their equivalents as defined by the claims, whether such embodiments are described earlier or later in this specification.

We claim:

1. A method for processing an incoming digital data stream from an open network and communicating extracted content across an analog air gap to a closed network, the method comprising the steps of:
(a) receiving a digital data stream from the open network;
(b) extracting digital content from the digital data stream and deleting digital data not extracted as digital content;
(c) converting the extracted digital content into analog character representations individually corresponding to members of a predefined character set;
(d) displaying the analog character representations on a display positioned on an open-network side of an analog air gap;
(e) transmitting the analog character representations across the analog air gap solely as optical representations;
(f) capturing the optical representations with an image sensor positioned on a closed-network side of the analog air gap to obtain captured images of the analog character representations;
wherein the captured images are interpreted as visual forms rather than discrete encoded numeric values; and
wherein communication across the analog air gap is limited to the captured analog character images.

2. The method of claim 1, wherein extracting digital content comprises the steps of:
(a) providing a predefined character set configured as a lookup table mapping binary values to corresponding analog characters;
(b) converting the digital data stream into binary values;
(a) comparing the binary values of the digital data stream with binary values corresponding to analog characters in a predefined character set; and
(b) deleting bytes that do not correspond to any analog character in the predefined character set.

3. The method of claim 2, further comprising the steps of:
(a) forming arrays of predefined length from the bytes corresponding to the predefined character set;
(b) determining whether each array represents digital content in context; and
(c) deleting arrays determined not to represent content in context.

4. The method of claim 3, wherein the steps of comparing, deleting, determining, converting, displaying, capturing, and reconstructing are performed by immutable processors configured to execute sets of immutable instructions stored in respective immutable memories coupled to respective immutable processors;
wherein each immutable processor is incapable of executing instructions other than immutable instructions stored in the immutable memory coupled to that immutable processor.

5. A method for processing an incoming digital data stream from an open network and communicating extracted content across an analog air gap to a closed network, the method comprising continuously performed steps of:
(a) receiving a digital data stream at a character filter immutable processor implementing a character filter by executing a first set of immutable instructions stored in a first immutable memory and including a predefined character set mapping binary values to corresponding analog characters;
(b) reading each byte of the digital data stream and placing the byte in a first memory buffer in received order;
(c) comparing the binary value of each byte with the binary value of the predefined character set;
(d) deleting bytes not corresponding to the predefined character set;
(e) outputting, remaining bytes to a second memory buffer in a context filter;
(f) repeating steps (a) through (e) for each byte in the digital data stream;
(g) analyzing, by a context filter immutable processor implementing a context filter by executing a second set of immutable instructions stored in a second immutable memory, arrays formed from the bytes and determining whether the arrays represent content in context;
(h) deleting arrays not representing content in context;
(i) outputting valid arrays to a third memory buffer in a display module;
(j) converting, by a display module immutable processor implementing a display module executing a third set of immutable instructions stored in a third immutable memory, each byte into a corresponding analog character representation, the analog character representations comprising isolated characters lacking machine-interpretable syntactic relationships and lacking executable semantics;
(k) displaying, the analog character representations across the analog air gap;
(l) capturing, by an image sensor the analog character representations and storing the captured analog character representations in a fourth memory buffer in an image processing module;
(m) processing, by an image processing module immutable processor implementing an image processing module executing a fourth set of immutable instructions stored in a fourth immutable memory, the captured analog character representations, wherein the processing comprises either:
(m1) reconstructing output data derived solely from recognition of the captured analog character representations using the predefined character set and not from encoded digital instructions; or
(m2) retaining the captured analog character representations without reconstruction into binary values; and
(n) outputting, by the image processing module, either:
(n1) in response to (m1), reconstructed output data containing only characters of the predefined character set and lacking executable semantics because binary-encoded digital data does not traverse the analog air gap; or
(n2) in response to (m2), the retained analog character representations.

6. An apparatus for transferring information from an open network to a closed network across an analog air gap, the apparatus comprising:
(a) an input interface configured to receive a digital data stream from the open network;
(b) a display device positioned on an open-network side of an analog air gap and configured to display analog character representations as optical representations derived from the digital data stream;
(c) an image sensor positioned on a closed-network side of the analog air gap and configured to capture the optical representations to obtain captured images of the analog character representations; and
(d) an image processing module configured to receive the captured images of the analog character representations from the image sensor; and
wherein communication across the analog air gap occurs solely by the display and capture of the optical representations of the analog character representations.

7. The apparatus of claim 6, further comprising a character filter including a processor and a memory storing a predefined character set mapping binary values to corresponding analog characters,
wherein the character filter excludes bytes not corresponding to an analog character in the predefined character set.

8. The apparatus of claim 7, further comprising a context filter configured to evaluate arrays formed from bytes corresponding to the predefined character set and exclude arrays not representing content in context.

9. The apparatus of claim 8, wherein the character filter, the context filter, the display module, and the image processing module each comprise a respective immutable processor coupled to an immutable memory storing immutable instructions;
wherein each immutable processor is incapable of executing instructions other than immutable instructions stored in the immutable memory coupled to that immutable processor; and
wherein each immutable processor defines an immutable processing boundary preventing modification of processing decisions by mutable execution logic.

10. The apparatus of claim 9, wherein the image processing module includes a fourth immutable processor configured to:
reconstruct output data derived solely from recognition of the captured analog character representations using the predefined character set of claim 7 and not from encoded digital instructions, the reconstructed output data containing only characters of the predefined character set and lacking executable semantics because binary-encoded digital data does not traverse the analog air gap; or
output the captured analog character representations without reconstruction into binary values.

11. An apparatus for transferring sanitized content from an open network to a closed network across an analog air gap, comprising:
(a) a character filter module including a character filter immutable processor and character filter immutable memory storing character filter immutable instructions including a predefined character set configured as a lookup table mapping binary numeric values to corresponding characters, the character filter module being configured to sequentially evaluate bytes of the digital data stream and to exclude bytes not corresponding to the predefined character set;
(b) a context filter module including a context filter immutable processor and context filter immutable memory storing a second set of immutable instructions and scripts, the context filter module being configured to form arrays from bytes corresponding to the predefined character set and to determine whether each array represents content in context;
(c) a display module including a display immutable processor and display immutable memory storing a third set of immutable instructions including a copy of the predefined character set, the display module being configured to convert bytes corresponding to the predefined character set into analog character representations and to display optical representations of the analog character representations on the open-network side of the analog air gap;
(d) an image processing module including an image processing immutable processor and image processing immutable memory storing a fourth set of immutable instructions including a copy of the predefined character set; and
(e) an image sensor positioned on the closed-network side of the analog air gap and configured to capture the optical representations of the analog character representations and provide the captured representations directly to the image processing immutable processor;
wherein the image processing immutable processor is configured to either:
(e1) translate the captured analog character representations into corresponding binary numeric values using the copy of the predefined character set and output the binary numeric values as sanitized non-executable data to an external subsystem, or
(e2) retain and output the captured analog character representations in analog form to an external subsystem configured to process the analog character representations without conversion into binary digital data; and
wherein unidirectional communication across the analog air gap consists solely of the analog character representations.
